(19) United States
(12) Patent Application Publication
(10) Pub. No.: US 2017/0234412 A1
(43) Pub. Date: Aug. 17, 2017

(54) THE SPECIFICATIONS APPARATUS THAT TRANSFORMS THE ENERGY IN THE COMPRESSED GASES INTO ROTATIONAL MOTION

(71) Applicant: Mustafa DAYANIK, Antalya (TR)

(72) Inventor: Mustafa DAYANIK, Antalya (TR)

(21) Appl. No.: 15/503,409

(22) PCT Filed: Jul. 28, 2015
(86) PCT No.: PCT/TR2015/000285

§ 371 Date: Feb. 13, 2017

(30) Foreign Application Priority Data
Aug. 11, 2014 (TR) 2014/09315

(51) Int. Cl. F16H 21/34

(52) U.S. Cl. CPC F16H 21/34

(57) ABSTRACT

This invention is a technological motor that increases, in each its period, the pressure of the gas that it compresses within the pressure volumes (BH) with the principle of communicating vessels, through the feature action—reaction of the mechanical system upon the acceleration of this system whose engine housing (MK) is the compressed gas tank. And this mechanic system is a motor which converts the potential energy in the compressed gases into kinetic energy without subjecting to chemical reaction. During these operations, the volume of the compressed gas in the engine housing (MK) does not change and it is not related to the mass volume of this motor, which is in direct proportion to the compressed gas pressure of the energy it produces. The motor with zero emission that is known for these features will be used in air, sea, land and space vehicles or charging their systems of these vehicles, which work with electrical energy, as the energy producer of the heating, cooling and lighting equipment.

### TECHNICAL AREA

This invention is about the mechanical set up which makes the transformation of the existing potential energy in the compressed gases into kinetic energy without subjecting to chemical reaction.

### PREVIOUS TECHNIQUE

Nowadays the transformation of linear force into rotational motion is made whit common, classic crankshafts. The crankshaft is an eccentric shaft and it is the element that converts the reciprocation of the pistons into rotational motion. It affects rotational motion as much as the intensity of the linear force. The crankshaft is one of the most expensive and important parts of all the machines. If the crankshaft is damaged, it is not possible to fix it and also the deformations that will appear in the manufacturing cannot be fixed later on. As for the other system; the piston that moves up and down on a center axis and this movement makes the rotational motion with the mechanism that converts into rotational motion on the same center axis via circular rail profile that continues agitational. This system facilitates the transformation of the up and down linear motion into rotational motion, but it does not add power to the rotational motion. Also there are manufacturing and installation difficulties besides the depreciation and friction losses as it is made of many elements. There is a technique, which I have its patent, with examination under the number of TR2009/07688 B. In this technique there are some problems of production and vibration that are problematic to solve. And this technique is the most ideal technological motor, appropriate for its purpose, in spite of the disadvantage of this technology that it does two jobs in one tour of rotation time in 360 degrees.

### THE PURPOSE OF THIS DEVICE

The purpose of this device is to produce a motor that works whit the pressure force of the compressed gas while converting the potential energy in these compressed gases into kinetic energy without the chemical reaction, without reducing the volume of the compressed gas which is available in its tank.

### EXPLANATIONS OF THE ILLUSTRATIONS

The apparatus that transforms the energy in the compressed gasses into rotational motion are illustrated in the attached illustrations, which are created for the invention to reach its aim. In these illustrations, the dimensions are shown with the (t) symbol which is taken as a base to determine ideal dimensions and shapes of the apparatus, which are appropriate for its function. In accordance with this base (t) dimension, the illustrations that analyses the diagrams and orbits which are drawn about the working principle of the system;

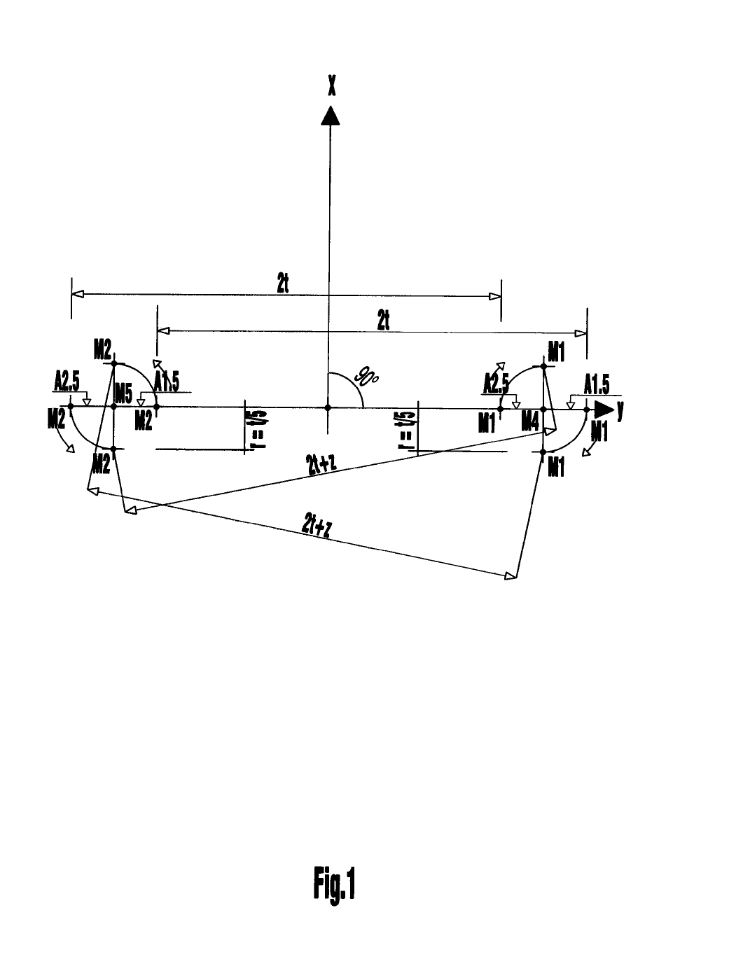

FIG. 1: M1, M4=t/5 and M2, M5=t/5, the eccentric center connected with the M4 center is M1. The eccentric center connected with the M5 center is M2. The distance between M1 and M2 is (2t) horizontally. Also the distance between M4 and M5 is (2t) which are the eccentric centers horizontally. When M4 and M5 centers rotate in reverse direction to each other in 90 degrees, the distance between M1 and M2 is (2t+z). The sliding length here is the sliding in the M2 center when M1 center is stable. Again, when it rotates in 270 degrees, the distance between M1 and M2 is again (2t+z). This sliding in here is the sliding distance in the M1 center when M2 center is stable. For this reason, the sliding tolerances must be applied in both centers.

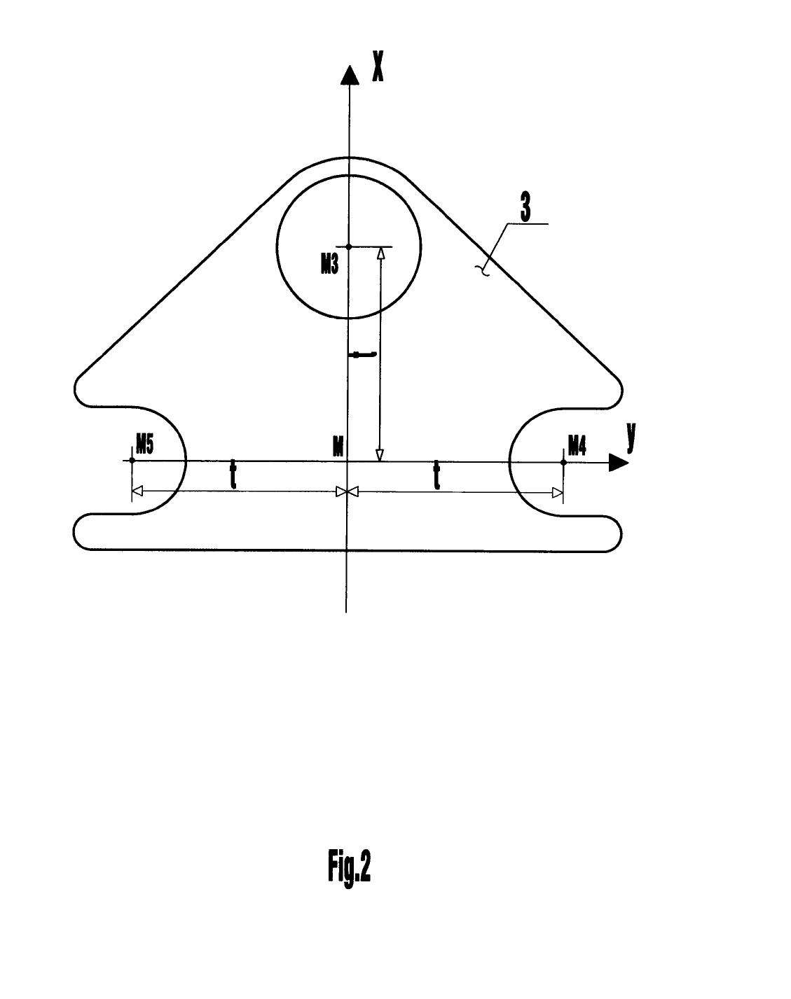

FIG. 2: M point, where (x) and (y) coordinates intersect, is equal to the distances of disk element (3) to M3, M4 and M5 centers and has the length of (t).

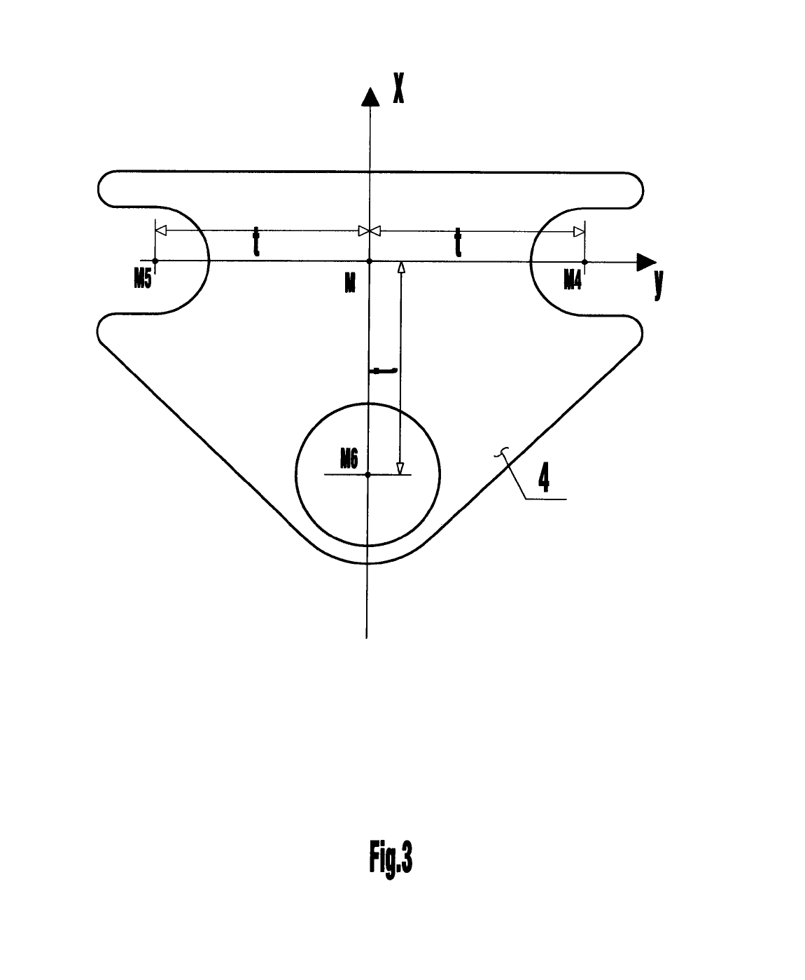

FIG. 3; M point, where (x) and (y) coordinates intersect, is equal to the distances of symmetric disk element (4) to M4, M5 and M6 centers and has the length of (t).

The determination of the diagrams that are drawn simultaneously by the M3 center of the disk element (3) that moves connected with the eccentric elements (A1.5) and (A2.5) that move in the opposite direction of each other in their centers end M6 center of the symmetric disc element (4);

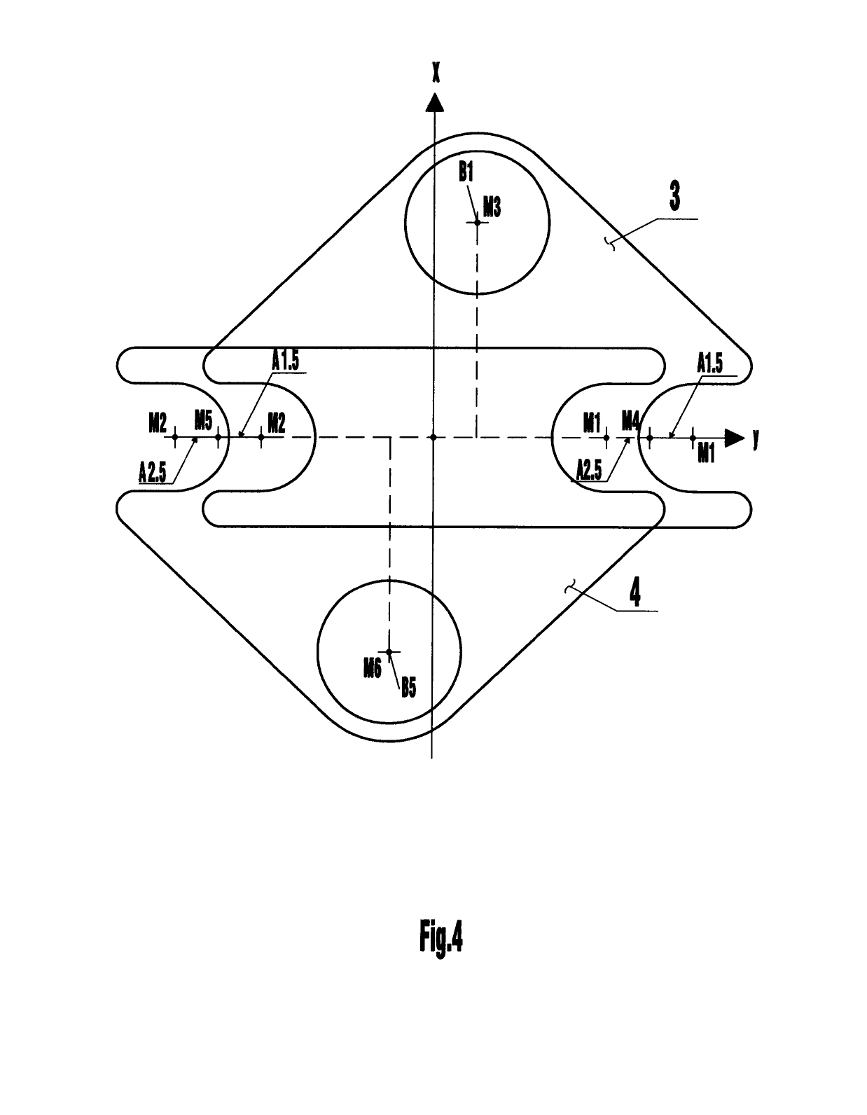

FIG. 4; The beginning point for the infinity symbol diagram is (B1) that will be drawn by the M3 point of disk element (3) that makes two-centered motion movement connected with the M1 and M2 eccentric rod of eccentric element (A1.5) whose rotation centers are M4 and M5. Also the beginning point for the infinity symbol diagram is B5 that will be drawn by the M6 point of symmetric disk element (4) that makes two-centered motion movement connected with the M1 and M2 eccentric rod of the eccentric element (A2.5), which is in the reverse symmetry of that.

FIG. 5; When the eccentric elements (A1.5) and (A2.5), whose rotation centers are M4 and M5, rotate for the first time in 90 degrees, the disk element (3) draw C1 diagram between B1-B2 and the symmetric disk element (4) draws C5 diagram between B5-B6.

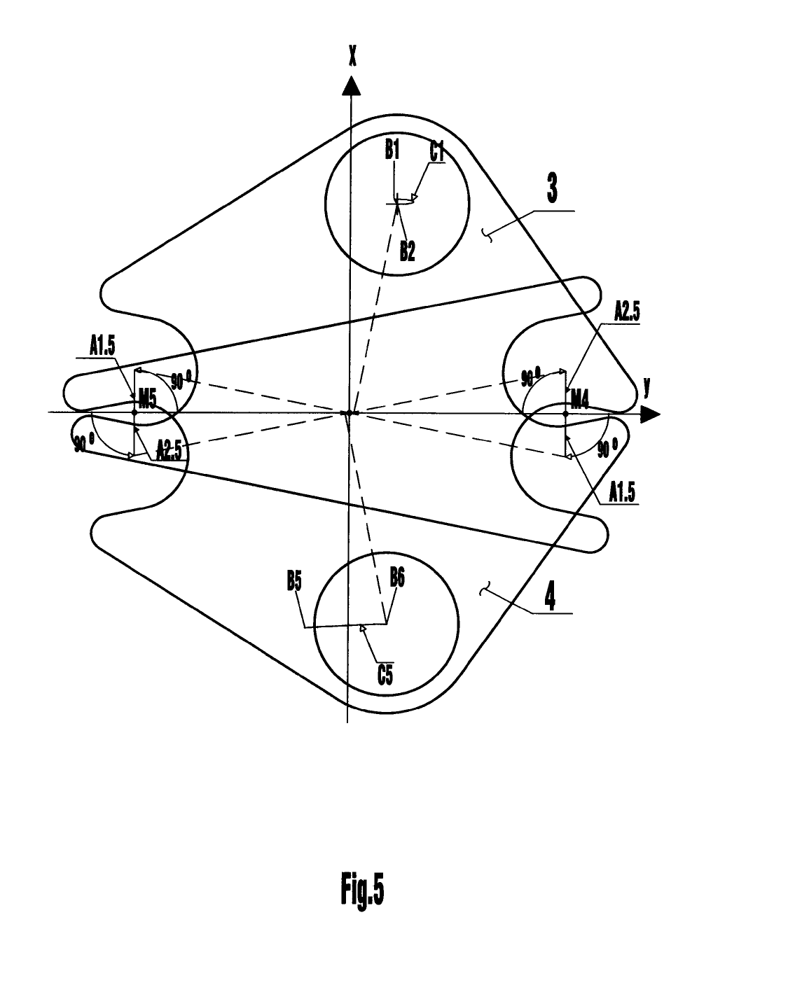

FIG. 6; When the eccentric elements (A1.5) and (A2.5), whose rotation centers are M4 and M5, rotate for the second time in 90 degrees, the disk element (3) draw C2 diagram between B2-B3 and the symmetric disk element (4) draws C6 diagram between B6-B7.

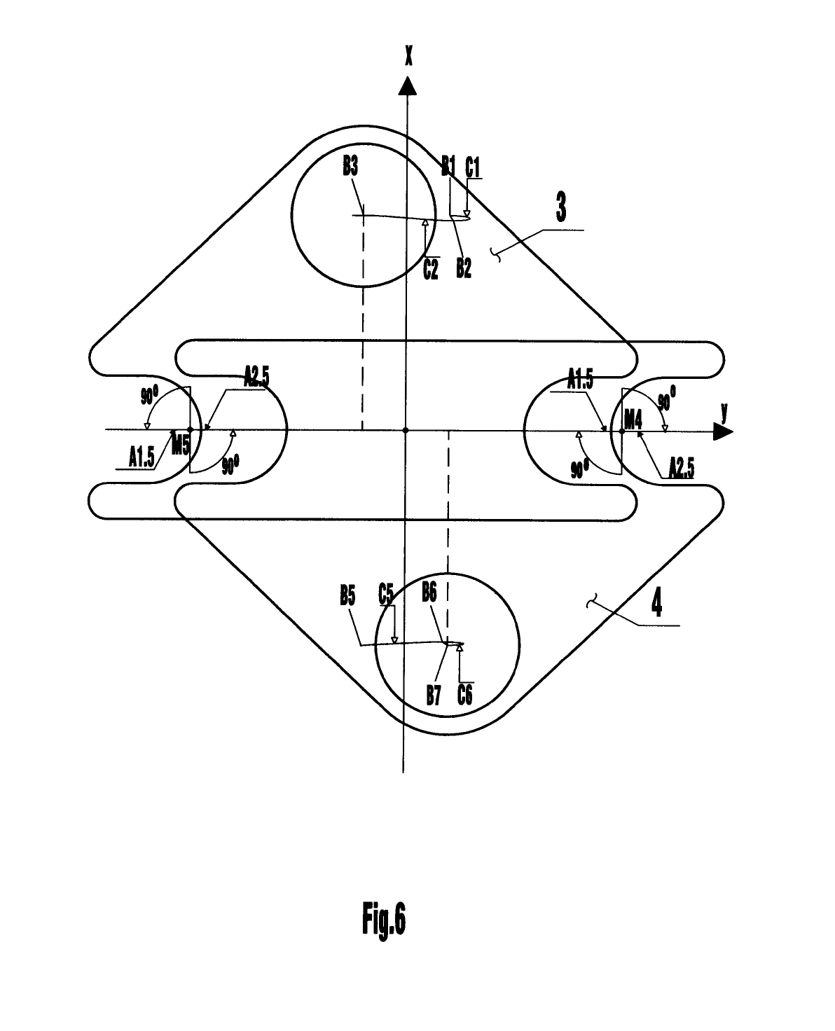

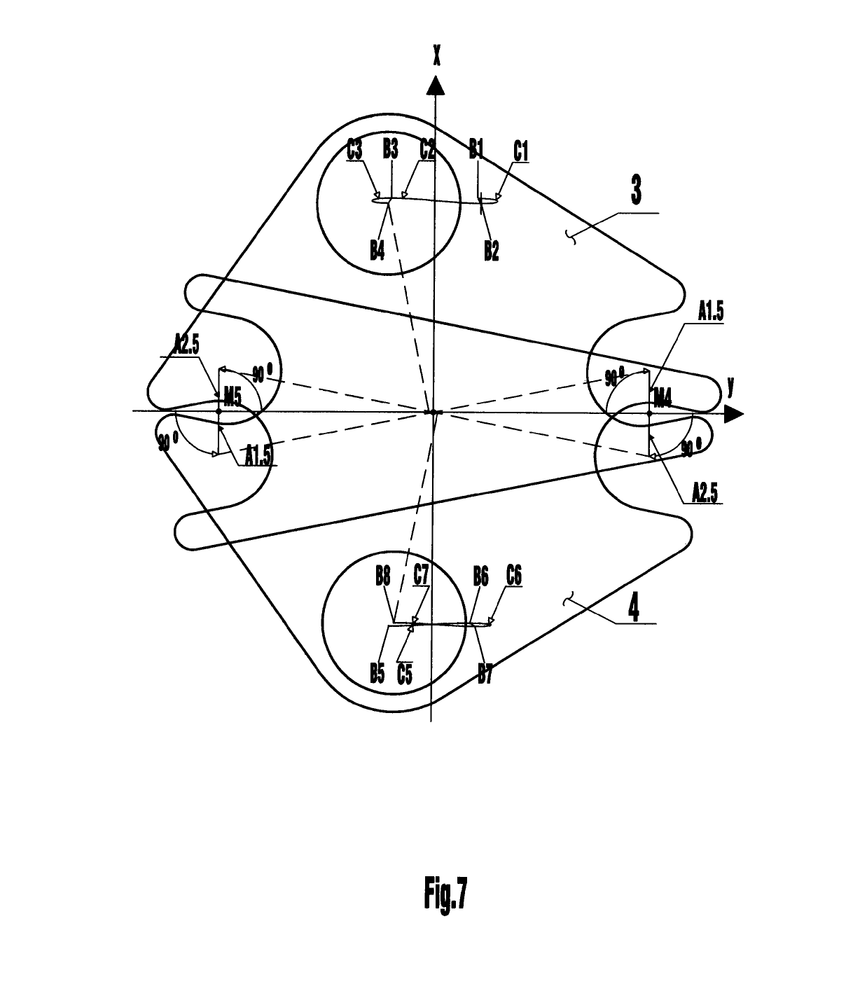

FIG. 7; When the eccentric elements (A1.5) and (A2.5), whose rotation centers are M4 and M5, rotate for the third time in 90 degrees, the disk element (3) draw C3 diagram between B3-B4 and the symmetric disk element (4) draws C7 diagram between B7-B8.

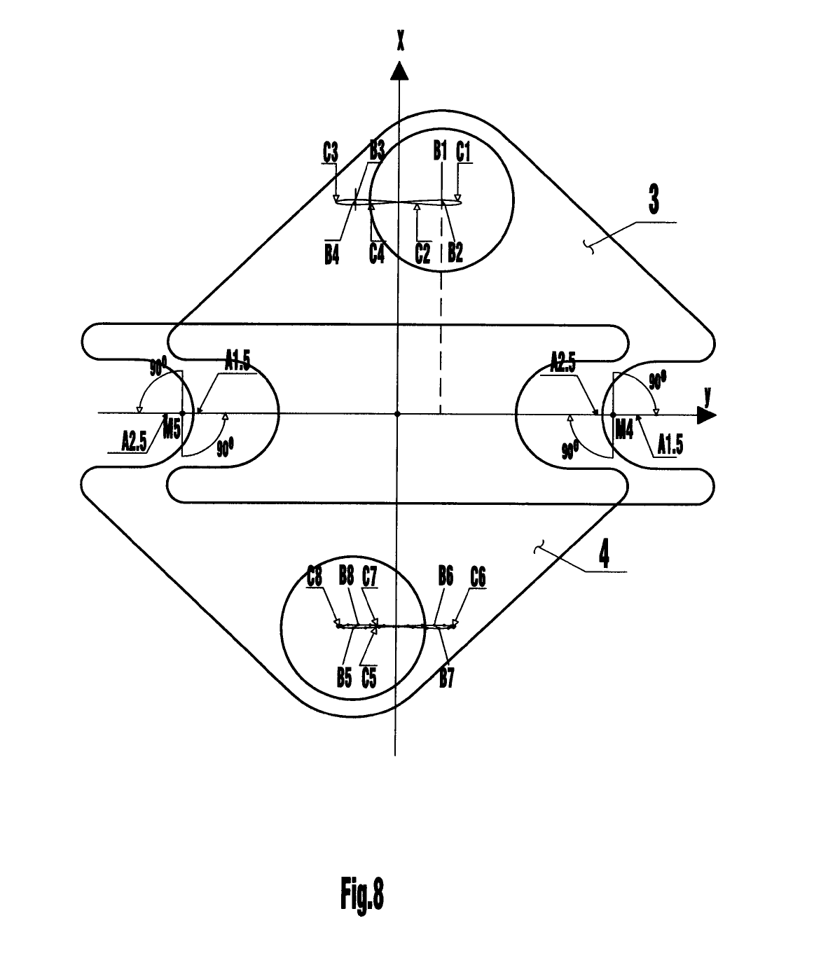

FIG. 8; When the eccentric elements (A1.5) and (A2.5), whose rotation centers are M4 and M5, rotate for the last time in 90 degrees, the disk element (3) draw C4 diagram between B4-B1 and the symmetric disk element (4) draws C8 diagram between B8-B5.

Determining eccentric distance of the shuttle element (A1.2)

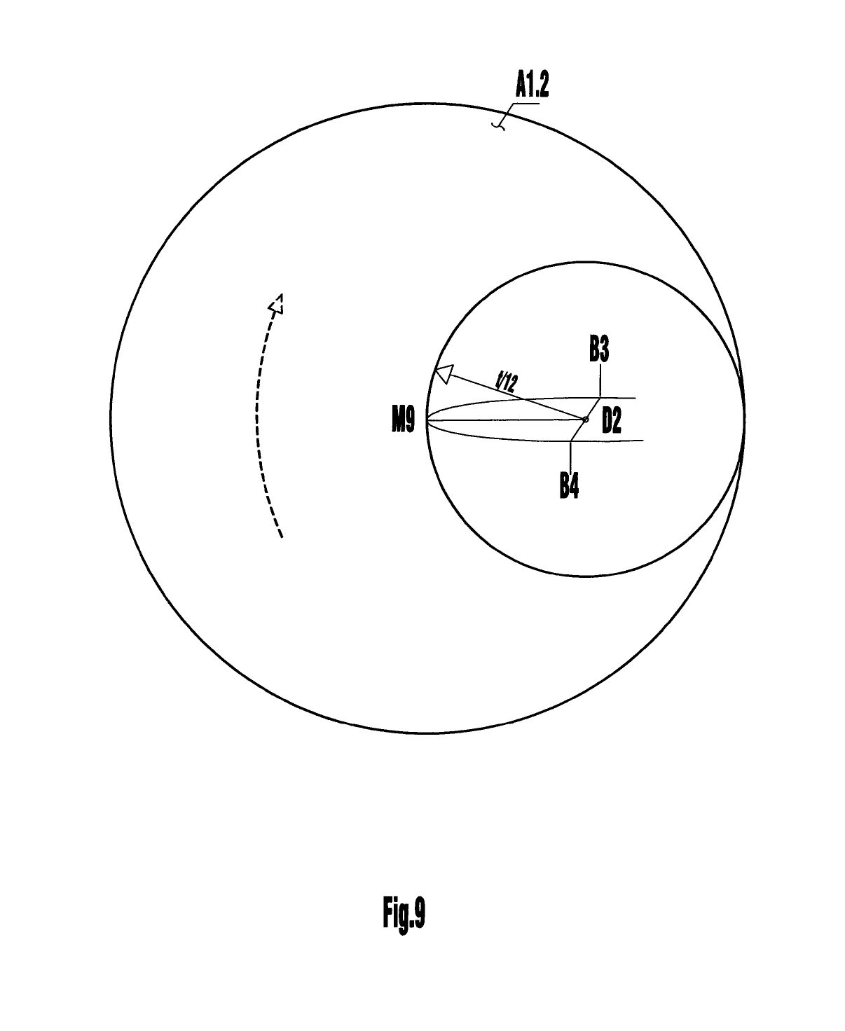

FIG. 9; (B3) Point is the point where the motion diagram in 180 degrees ends. The distance between B3 and B4 points is motion diagram in 90 degrees. The eccentric center of shuttle element (A1.2) has to be in an equal distance to (B3), which is the start point, and B4 point, is the end the diagram in 90 degrees. As the orbit of the center of shuttle element (A1.2) is diagram, the diameter of the circle, which is tangent to the end point of the diagram from D2 point, is the eccentric sliding distance of shuttle element (A1.2). This distance is determined as (r=t/12). The position of the shuttle element (A1.2) in the D2 and M9 axis is the end of its D2 centered rotation counter clockwise, and it is the starting location of its clockwise rotation.

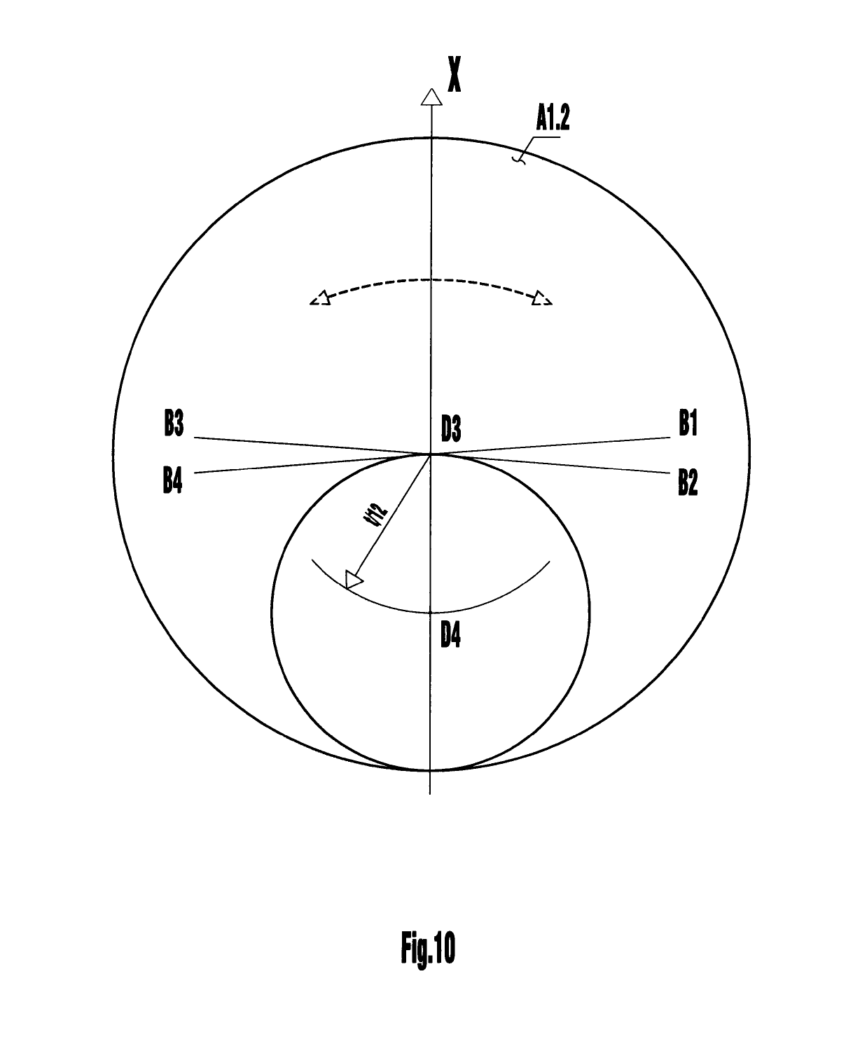

FIG 10; (B2) Point is the point where the motion diagram in 90 degrees ends. The distance between B2 and B3 point is the second motion diagram in 90 degrees. B4 point is the point where motion diagram in 270 degrees ends. The distance between B4 and B1 point is the fourth motion diagram in 90 degrees. The intersection point of B2, B3 and B4, B1 diagrams is the D3 point on axis (x). D4 point, which the circle with the diameter of (r=t12) that is drawn from this point cuts the (x) axis, as it is equally distant from both diagrams, is the eccentric center of the shuttle element (A1.2). The shuttle element (A1.2) makes its two-way motions throughout the straight lines of these two diagrams.

FIG. 11; (B1) Point is the beginning point of motion diagram. The distance between B1 and B2 points is the motion diagram in 90 degrees. The eccentric center of shuttle element (A1.2) has to be in an equal distance to (B1), which is the start point, and B2 point, which is the end point of the diagram in 90 degrees. As the orbit of the center of shuttle element (A1.2) is diagram, the diameter of the circle which is tangent to the diagram's end point from D1 point, is the eccentric sliding distance of shuttle element (A1.2). This distance is determined as (r=t/12). The position of the shuttle element (A1.2) in the D1 and M10 axis is the end of its D1 centered rotation counter clockwise, and it is the starting location of its counter clockwise rotation.

Determining the oscillation axis of the hammer (A1.1) and oscillation boundary,

FIG. 12; The determined eccentric centers of shuttle element (A1.2) are D1, D2 and D4. The center of the circle which is passing these points is on the (x) axis and is M11, which is the oscillation axis. The straight line that combines D1 and M11 points is the tip oscillation boundary counter clockwise and the straight line that combines D2 and M11 points is the tip oscillation boundary counter clockwise and it happens between these two straight lines.

The explanation of the creation of the opposing forces made by apparatus A1;

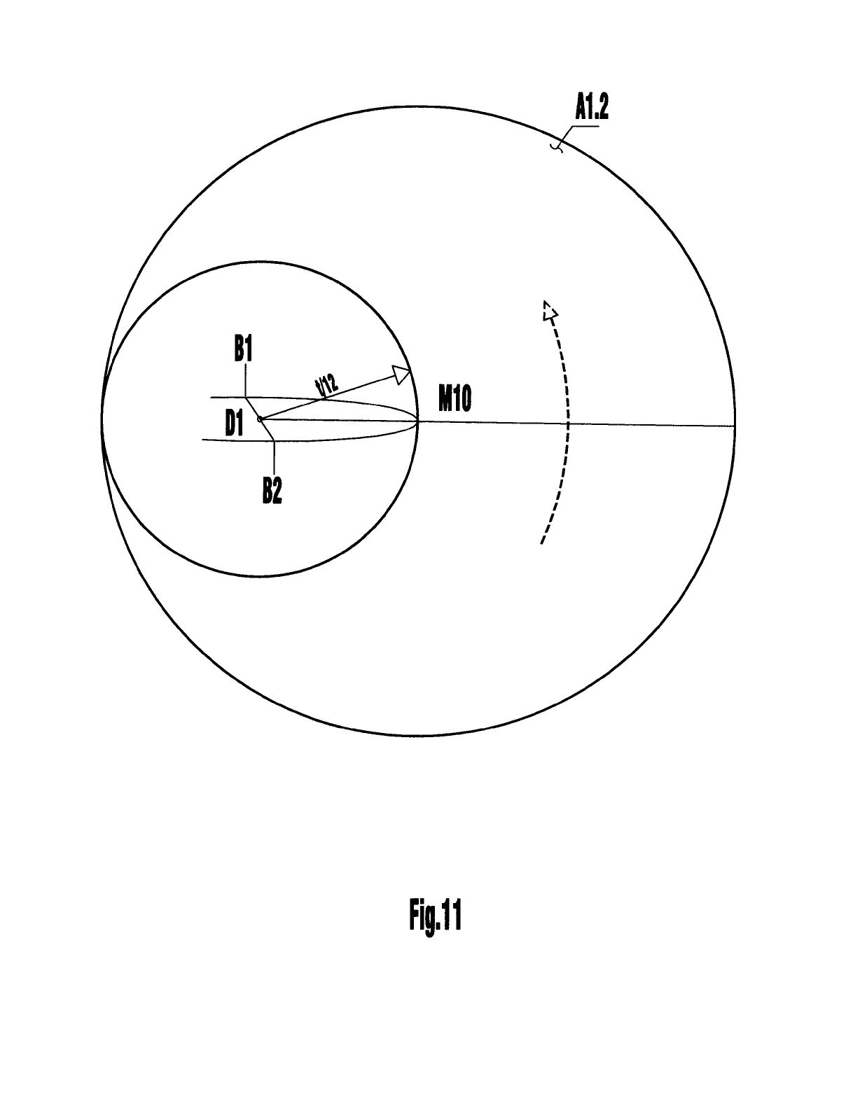

FIG. 13; When the center of the shuttle element (A1.2) of the accelerating mechanic system comes to the rotation point (B1) on the diagram it has drawn, the straight line of oscillation axis, which passes the fixed and joint point (M11) of the hammer element (A1.1) that moves connected to the eccentric center of the shuttle element (A1.2) makes an angle of 15.6° with the straight line of tip oscillation axis. The system is balanced at the position when the straight line which combines the rotation point (B1) and eccentric center of the shuttle element (A1.2) makes the (v) angle in the eccentric center of the shuttle element (A1.2) with the straight line of oscillation axis of hammer element (A1.1). When the eccentric elements (A1.5) that move connected to the gear group (6) of the accelerating system rotate reversely to each other, they accelerate the disc element (3) clockwise and as the shuttle element (A1.2) in its bearing with the center (M3) is connected to the hummer element (A1.1) from the eccentric center and all the distances to this points are fixed, it has to rotate around its center clockwise. While the shuttle element (A1.2) makes this movement, load tip of eccentric center, the center of motion the point of this straight line which cuts the orbit turn into a leverage with a forge tip (k), the (v) angle widens. Fixed (M11) and jointed center of the oscillation axis of hummer element (A1.1) which moves according to the leverage principles always be the bearing point, it changes according to the position of the other two tip oscillation distance. If its movement is counter clockwise from the tip oscillation angle clockwise; The point in the range (CK1) of 71° angle is the force tip, it turns into a leverage which works as a tip load in the range of 15.6° angle. The pistons (16a-16b) of the apparatus (A1) are connected to (CK1) point via piston rods (17a-17b). When apparatus is in this position, its (v) angle grows when it transmits the gas pressure force to disc element (3) which moves clockwise which the shuttle element (A1.2) is connected. The buoyancy force rate of the leverage system created by the force that continues its rotation clockwise in its center of the shuttle element (A1.2) is bigger than the buoyancy force rate of the leverage system created by the hammer element (A1.1). The opposing force which is created via this technique constantly produces the compression force which is needed to compress the gases, as a feature of the system, until it completes the range of 15.6° angle. The rotation point (B1) and these functions that are created after that accelerate the apparatus (A1), which enables it repeating exactly, symmetrically in the rotation point (B3) of the diagram where it has a range of 180° angle, the system in one tour of time for two times.

Determining the eccentric distance of the symmetric shuttle element (A2.2);

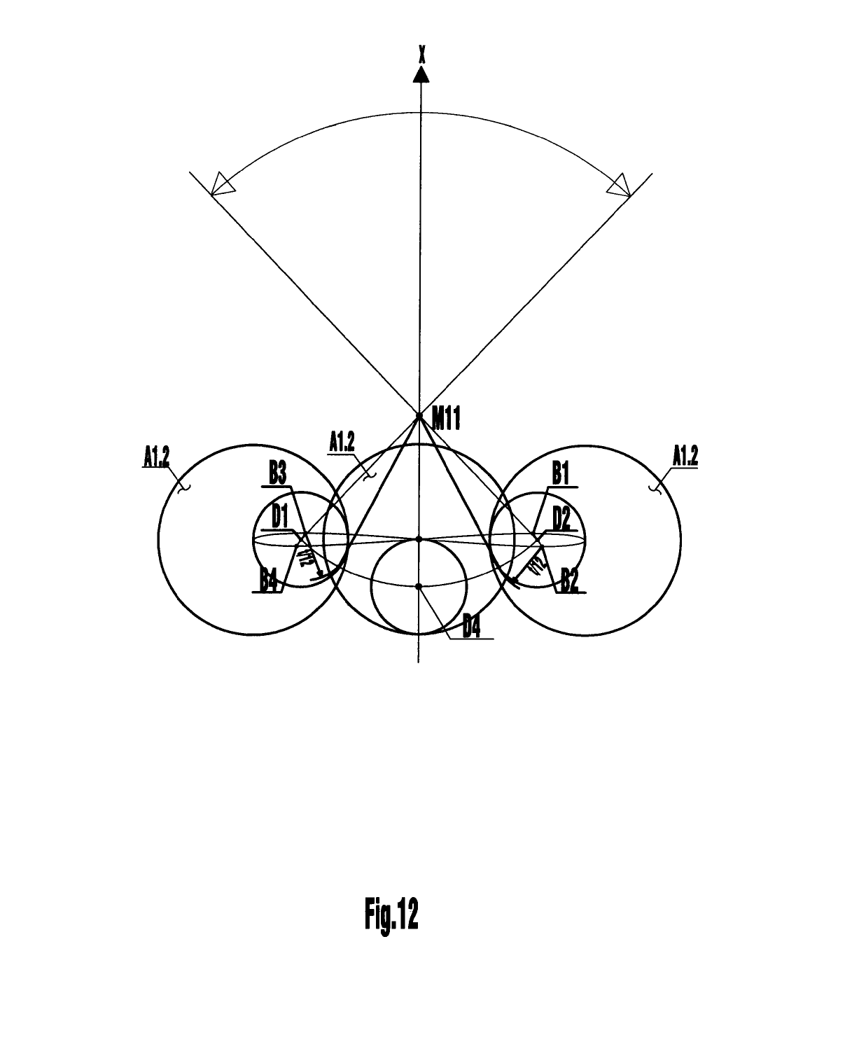

FIG. 14; (B8) point is the point where the motion diagram in 270 degrees ends. The distance between (B8) and (B5) points is motion diagram in 90 degrees. The eccentric center of the shuttle element (A2.2) must have equal distance to beginning (B8) and the end point (B5) of the diagram in 90 degrees. As the orbit of the shuttle element's (A2.2) center is a diagram, the diameter of the circle which is tangent to the end point of the diagram from the (G2) point is the eccentric shifting distance of the shuttle element (A2.2). This distance is determined as (r=t/12). The position of the shuttle element (A2.2) in the (G2) And (N9) axis is the end of counter clockwise rotation with (G2) center, clockwise is the beginning position of the rotation.

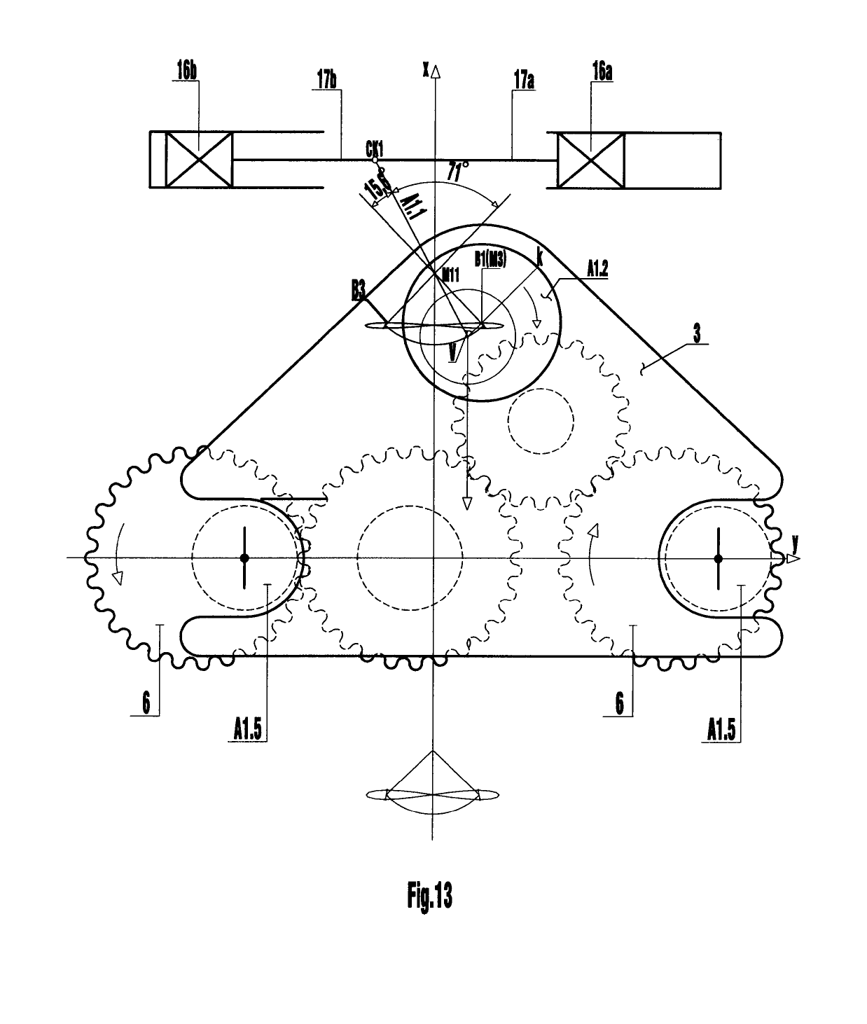

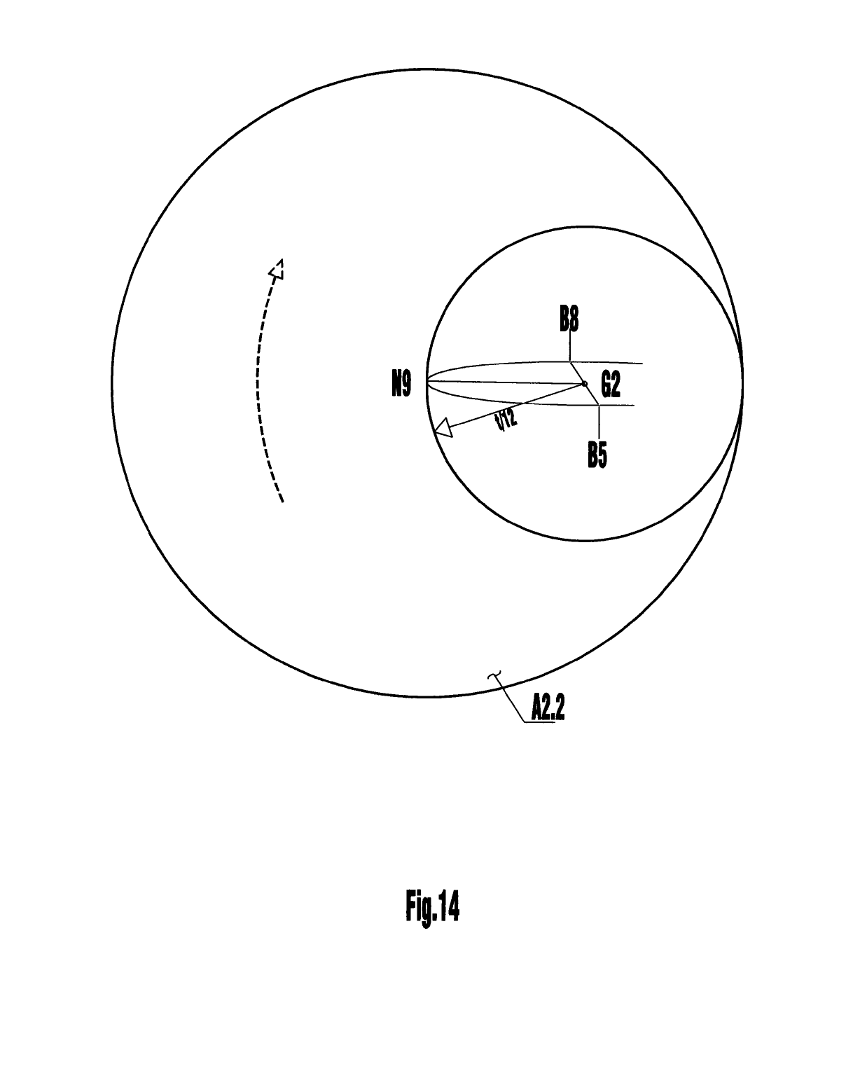

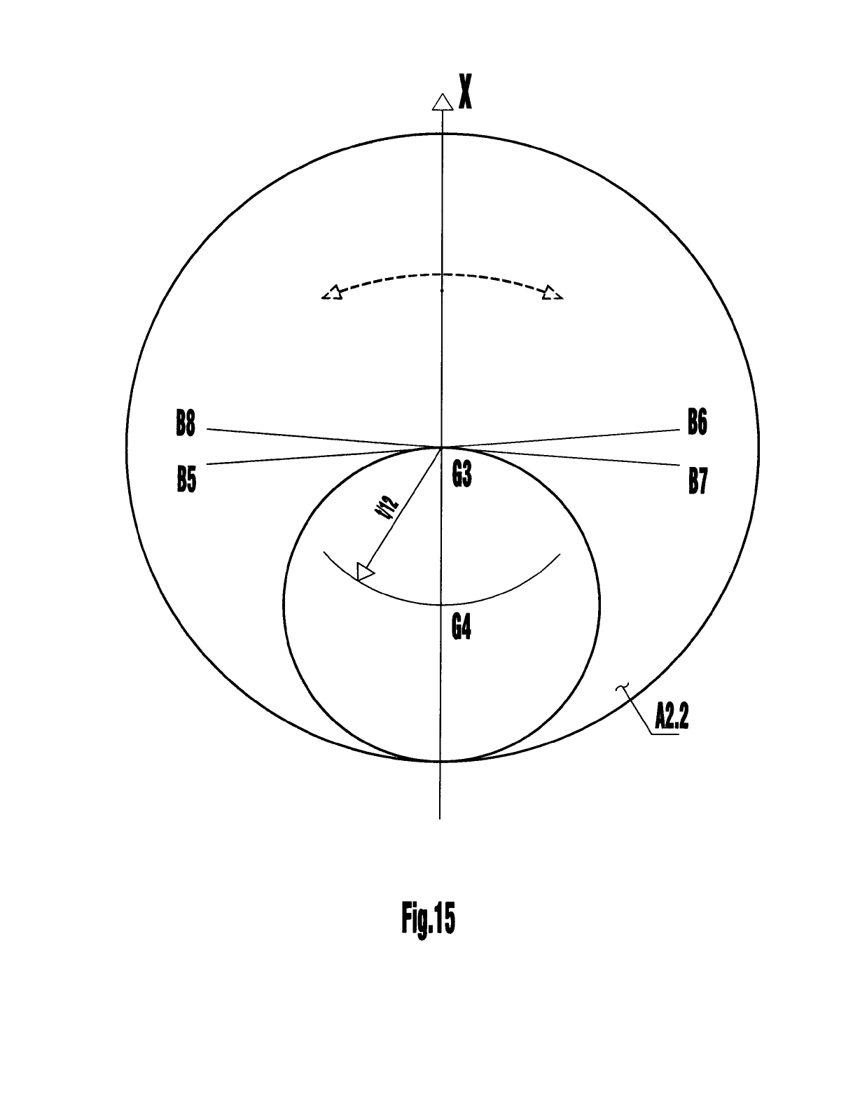

FIG. 15; (B7) point is the point where the motion diagram in 180 degrees ends. The distance between (B7) and (B8) points is the third motion diagram in 90 degrees. (B5) point is the point where the motion diagram in 360 degrees ends. The distance between (B5) and (B6) points is the first motion diagram in 90 degrees. The intersection point of (B7), (B8) and (B5), (B6) diagrams is the (G3) point on the (x) axis. As (G4) point, which cuts the (x) axis of the circle with a diameter of (r=t/12) which is drawn from the mentioned point, has equal distance to both diagrams, it is the eccentric center of the shuttle element (A2.2). The shuttle element (A2.2) makes its two-way motions throughout this diagram line.

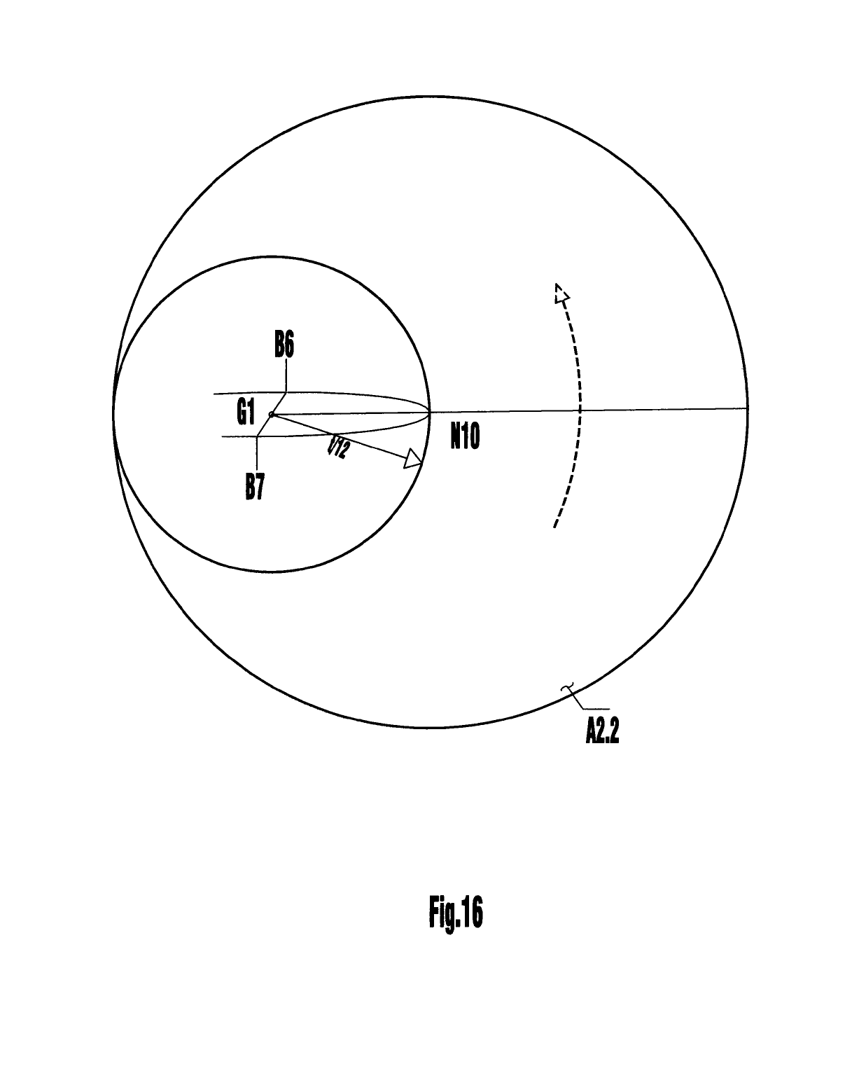

FIG. 16; The distance between (B6) and (B7) points is the second motion diagram in 90 degrees. The eccentric center of the shuttle element (A2.2) must have equal distance to the beginning point (B6) and end point (B7) of the second diagram in 90 degrees. As the orbit of the shuttle element's (A2.2) center is a diagram, the diameter of the circle which is tangent to the end point of the diagram from the (G1) point is the eccentric shifting distance of the shuttle element (A2.2). This distance is determined as (r=t/12). The position of the shuttle element (A2.2) in the (G1) and (N10) axis is the end of clockwise rotation of the shuttle element (A2.2) with (G1) center, counter clockwise is the beginning position of the rotation.

Determining the oscillation axis of the hammer (A2.1) and oscillation boundary;

FIG. 17; The determined eccentric centers of shuttle element (A2.2) are (G1), (G2) and (G4). The center of the circle which is passing these points is on the (x) axis and is (N11) which is the joint oscillation center. The straight line that combines (G1) and (N11) points is the tip oscillation boundary counter clockwise and it happens between these two straight lines.

The explanation of the creation of the opposing forces made by apparatus A2;

FIG. 18; When the center of the shuttle element (A2.2) of the accelerating mechanic system comes to the rotation point (B6) on the diagram it has drawn; the straight line of oscillation axis, which passes the fixed and joint point (N11) of the hammer element (A2.1) that moves connected to the eccentric center of the shuttle element (A2.2) makes an angle of 19.4° with the straight line of tip oscillation axis. The system is balanced at the position when the straight line which combines the rotation point (B6) and eccentric center of the shuttle element (A2.2) makes the (q) angle in the eccentric center of the shuttle element (A2.2) with the straight line of oscillation axis of hammer element (A2.1). When the eccentric elements (A2.5) that move connected to the gear group (6) of the accelerating system rotate reversely to each other, they accelerate the symmetric disc element (4) clockwise and as the shuttle element (A2.2) in its bearing with the center (M6) is connected to the hummer element (A2.1) from the eccentric center and all the distances to this points are fixed, it has to rotate around its center clockwise. While the shuttle element (A2.2) makes this movement; load tip of eccentric center, the center of motion the point of this straight line which cuts the orbit turn into a leverage with a forge tip (s), the (q) angle widens. Fixed (M11) and jointed center of the oscillation axis of hummer element (A2.1) which moves according to the leverage principles always be the bearing point, it changes according to the position of the other two tip oscillation distance. If its movement is counter clockwise from the tip oscillation angle clockwise; the point in the range (CK2) of 74.6° angle is the force tip, it turns into a leverage which works as a tip load in the range of 19.4° angle. The pistons (16c-16d) of the apparatus (A2) are connected to (CK2) point via piston rods (17c-17d). When apparatus is in this position, its (q) angle grows when it transmits the gas pressure force to symmetric disc element (4) which moves clockwise which the shuttle element (A2.2) is connected. The buoyancy force rate of the leverage system created by the force that continues its rotation clockwise in its center of the shuttle element (A2.2) is bigger than the buoyancy force rate of the leverage system created by the hammer element (A2.1). the opposing force which is created via this technique constantly produces the compression force which is needed to compress the gases, as a feature of the system, until it completes the range of 19.4° angle. The rotation point (B6) and these functions that are created after that accelerate the apparatus (A2), which enables it repeating exactly, symmetrically in the rotation point (B8) of the diagram where it has a range of 180 angle, the system in one tour of time for two times. The 90° angle is formed between the acceleration start of this apparatus (A2) and the acceleration start of apparatus (A1).

FIG. 19; It is the section (1-1) view of the elements of the apparatus, which produces rotational motion from the energy in the compressed gases, that are placed in the dimensions that are determine according to their functions.

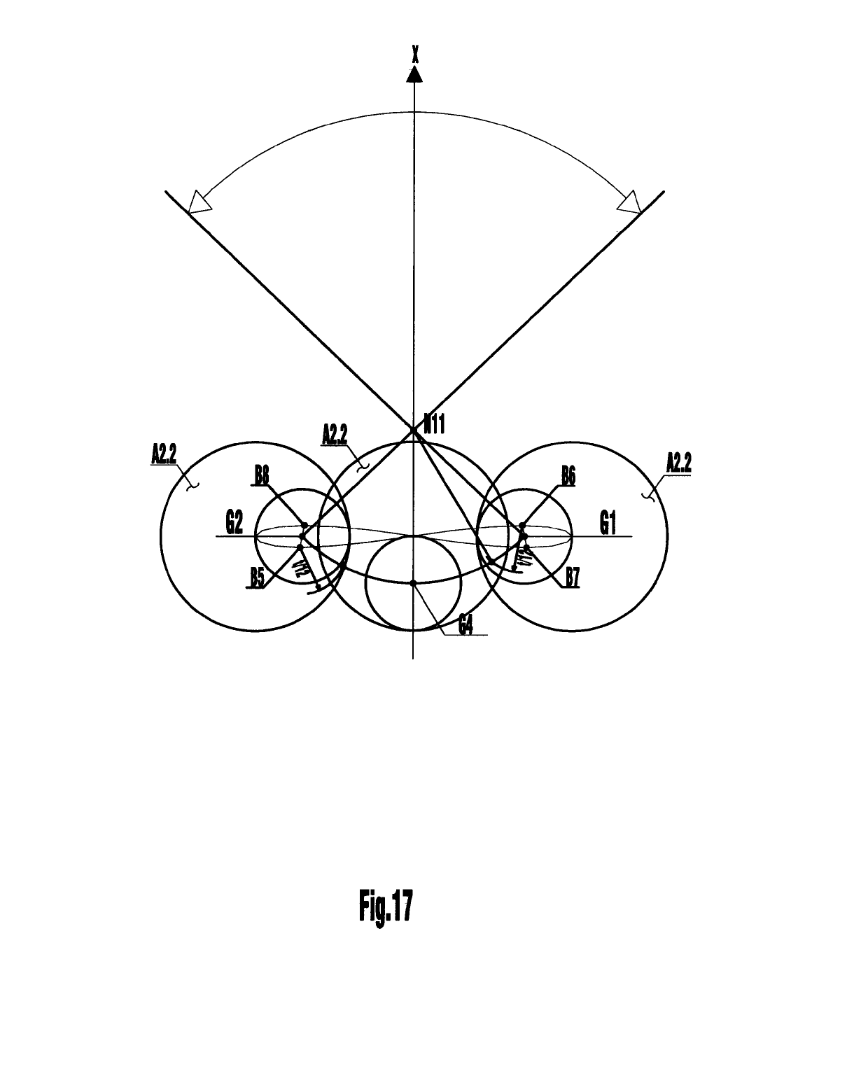

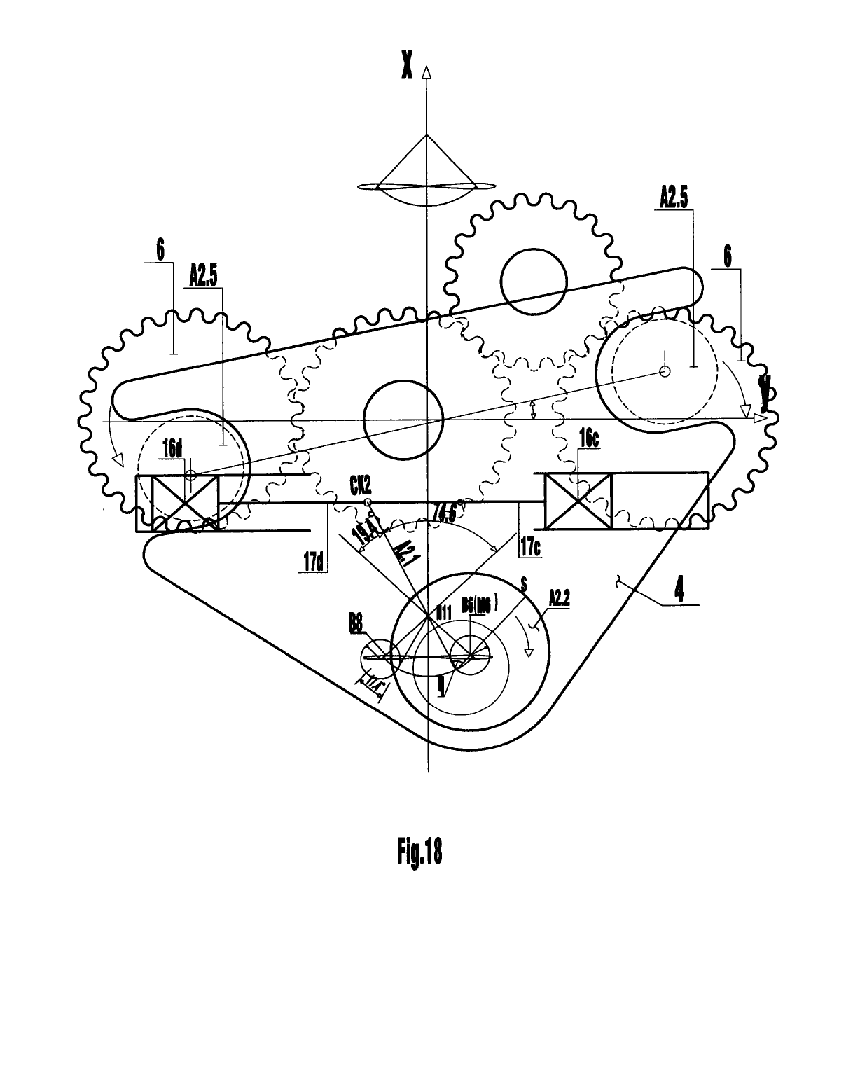

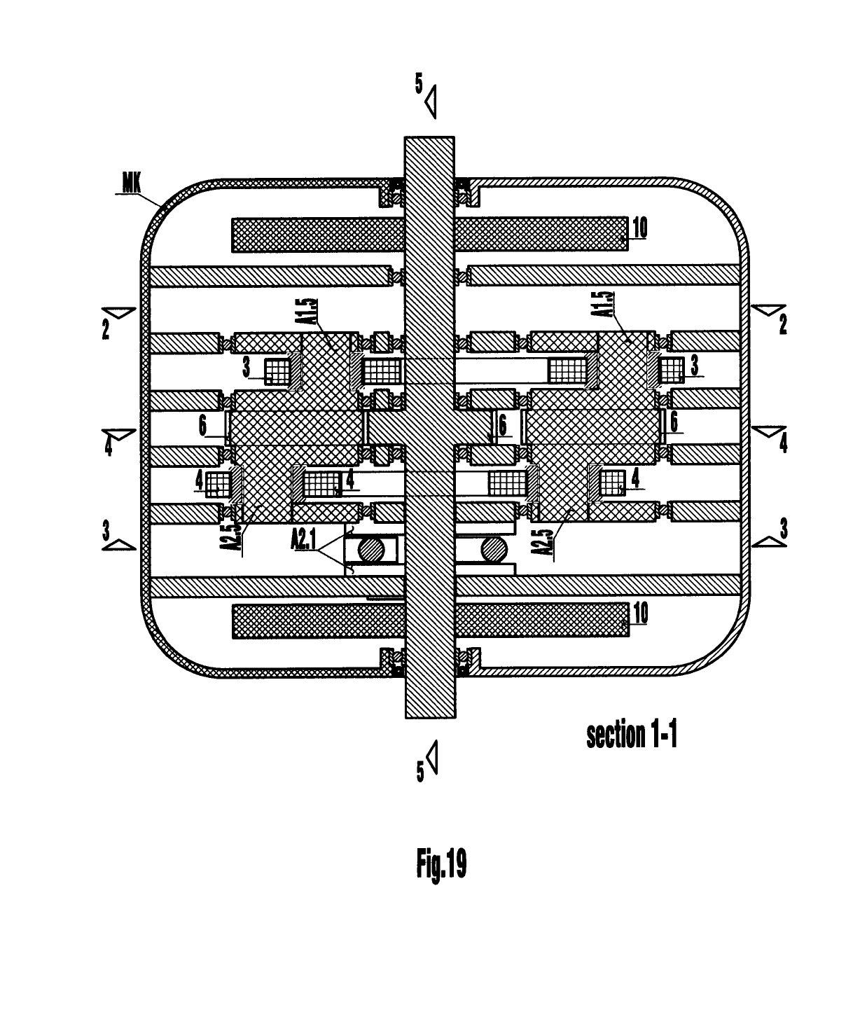

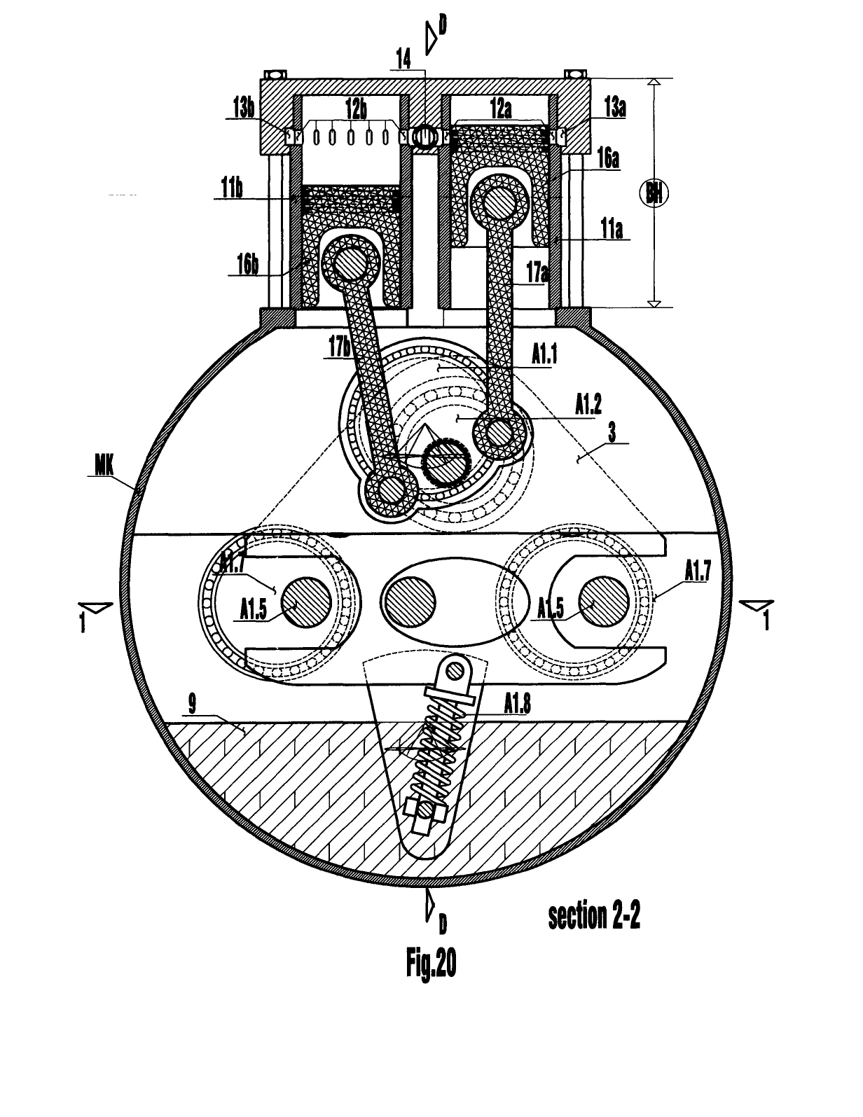

FIG. 20; It the position of the piston that is 15.6° distant to the tip oscillation angle in the (2-2) section of the apparatus which produces rotational motion from the energy in the compressed gases.

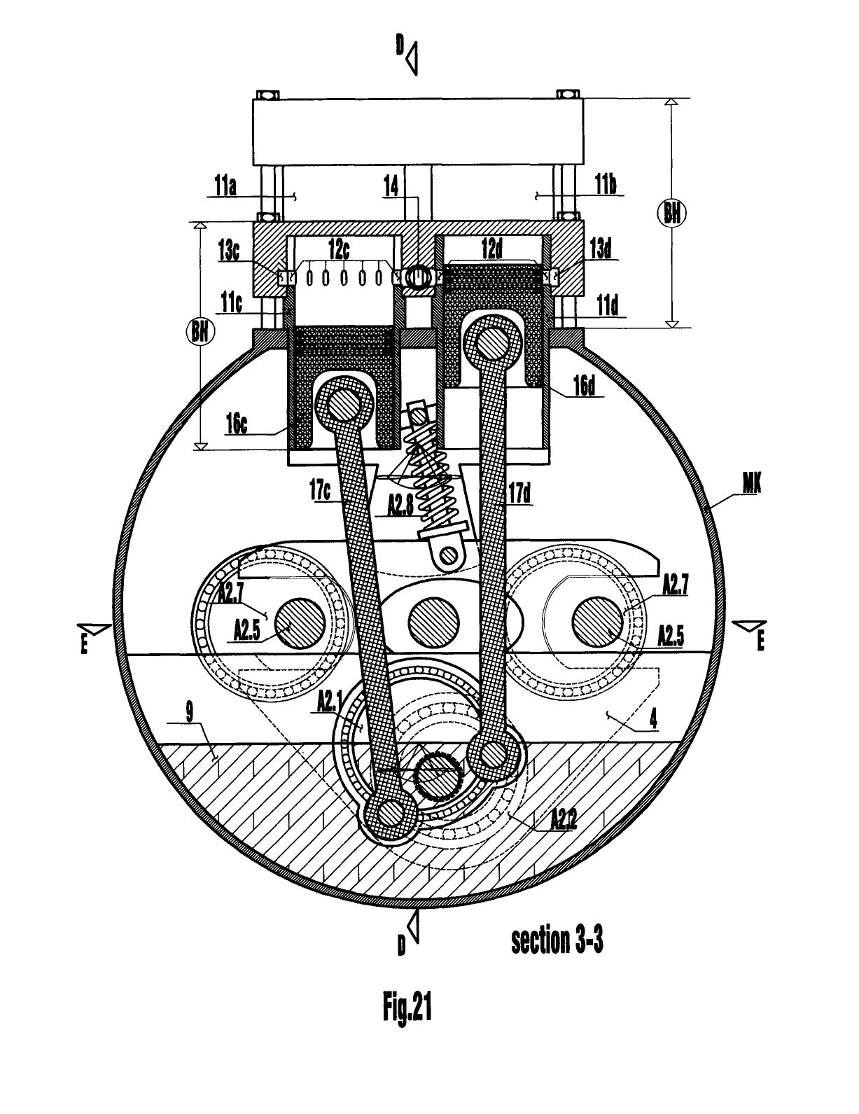

FIG. 21; It is the position of the piston that is 19.4° distant to the tip oscillation angle in the (3-3) section of the apparatus which produces rotational motion from the energy in the compressed gases.

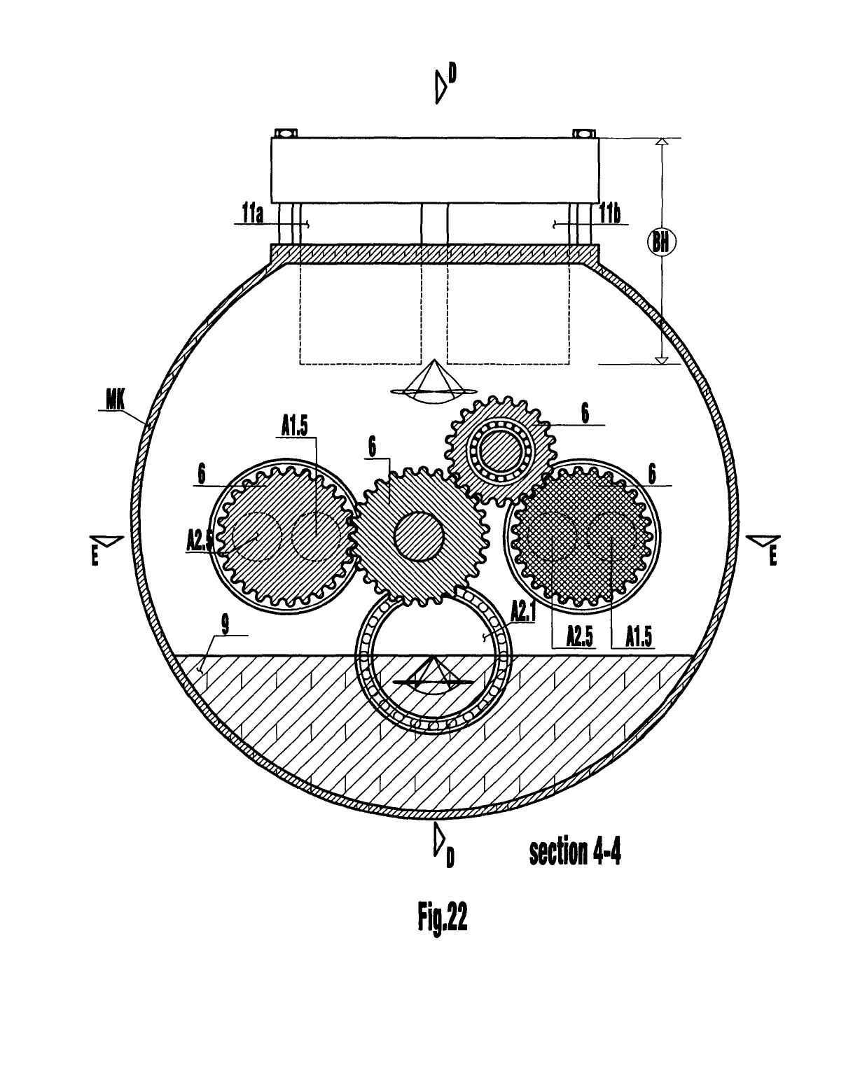

FIG. 22; (4-4) section view of the shared gear (6) group of the apparatus which produces rotational motion from the energy in the compressed gases.

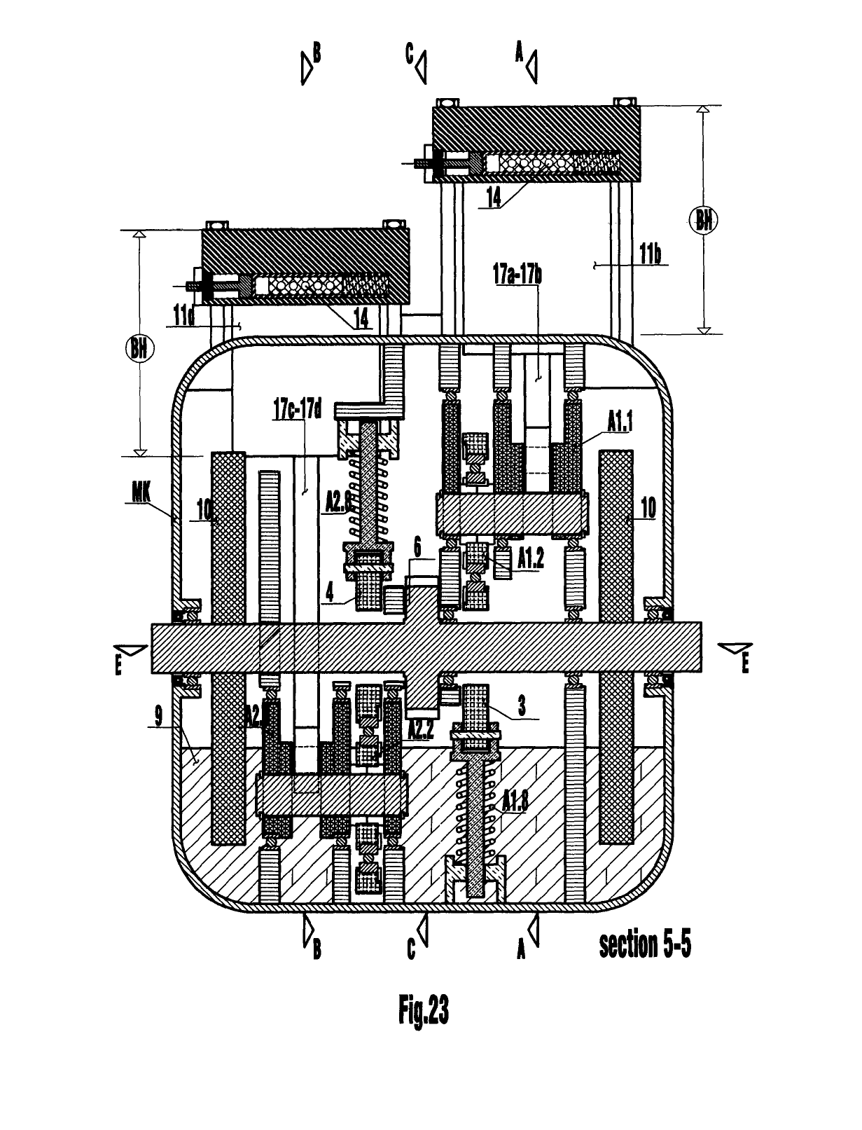

FIG. 23; (5-5) section view of the apparatus which produces rotational motion from the energy in the compressed gases.

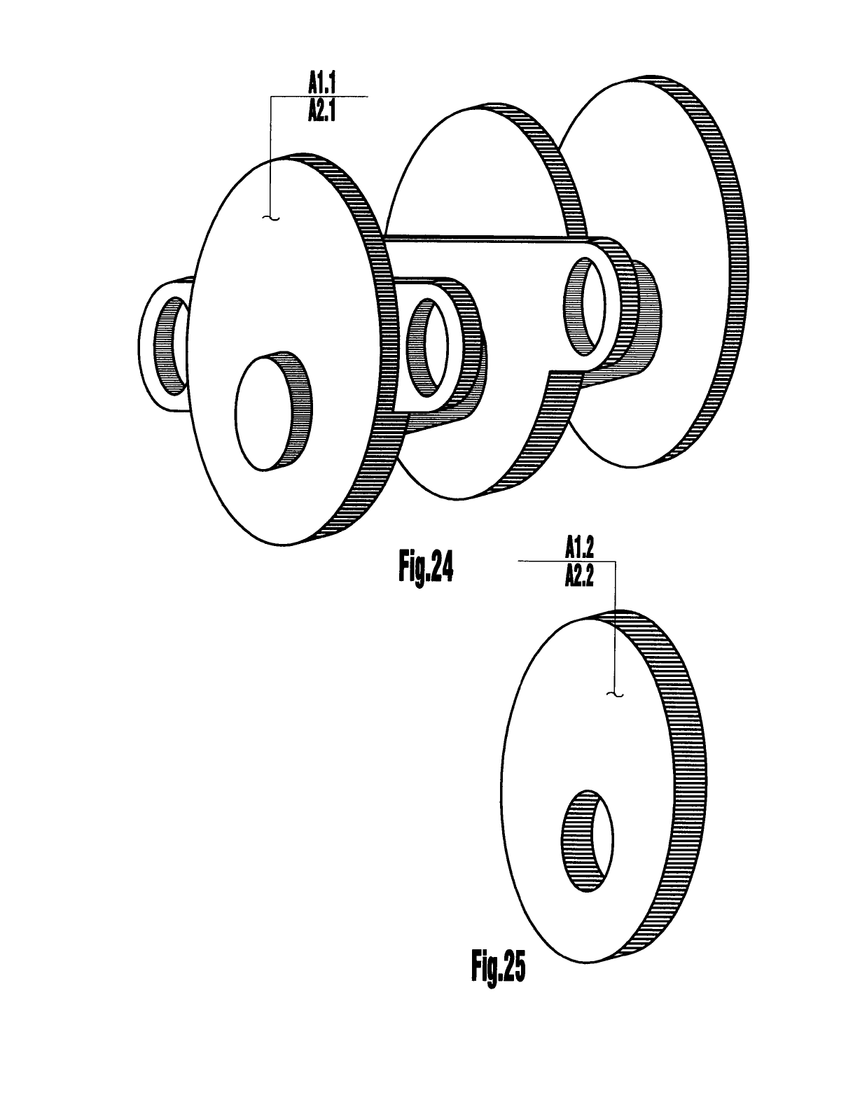

FIG. 24; It is the perspective view of the hammer element (A1.1) and (A2.1).

FIG. 25; It is the perspective view of the shuttle element (A1.2) and (A2.2).

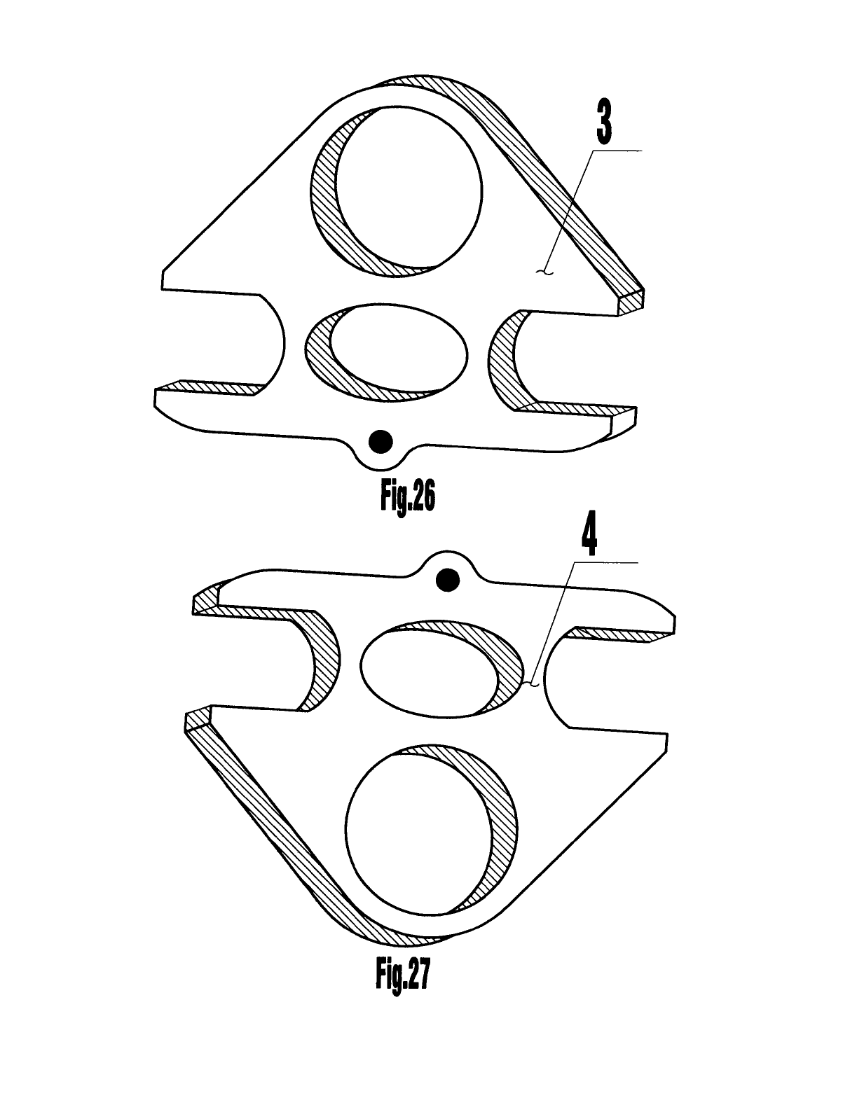

FIG. 26; It is the perspective view of the disk element (3).

FIG. 27; It is the perspective view of the symmetric disk element (4).

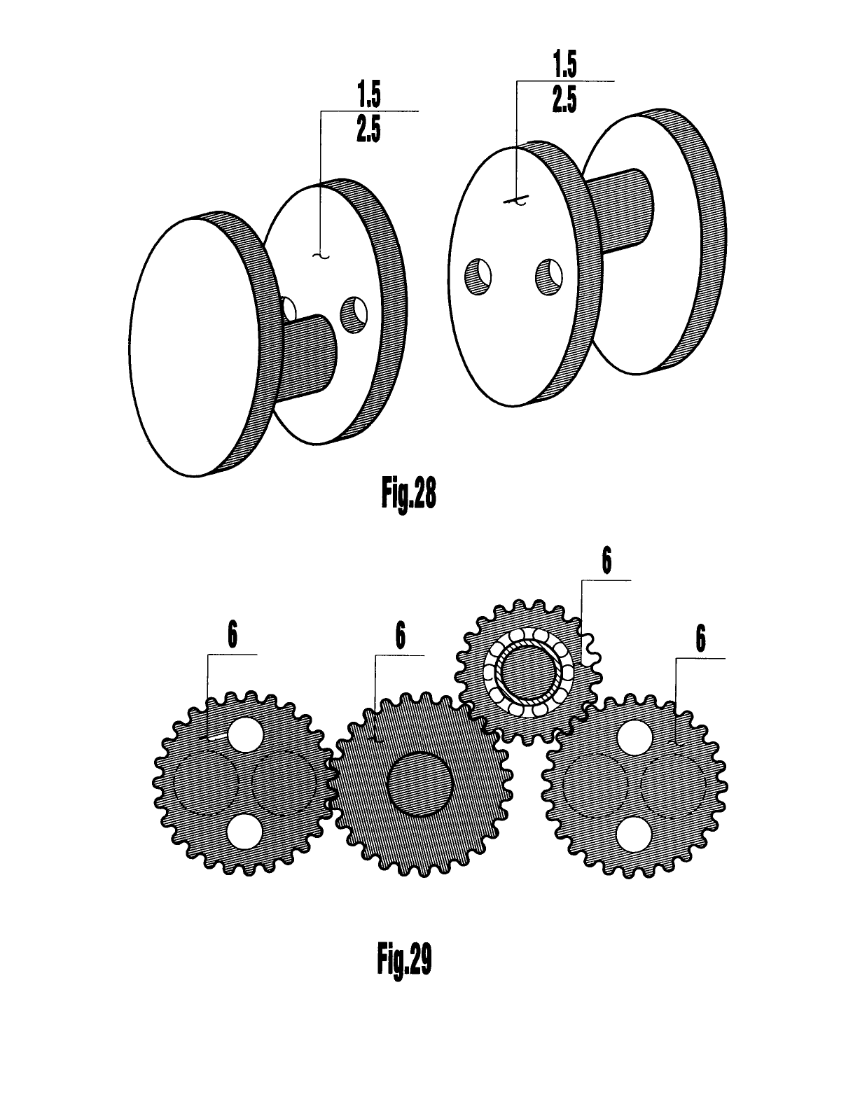

FIG. 28; It is the perspective view of the eccentric element (A1.5) and (A2.5).

FIG. 29; It is the plan view of the gear group (6).

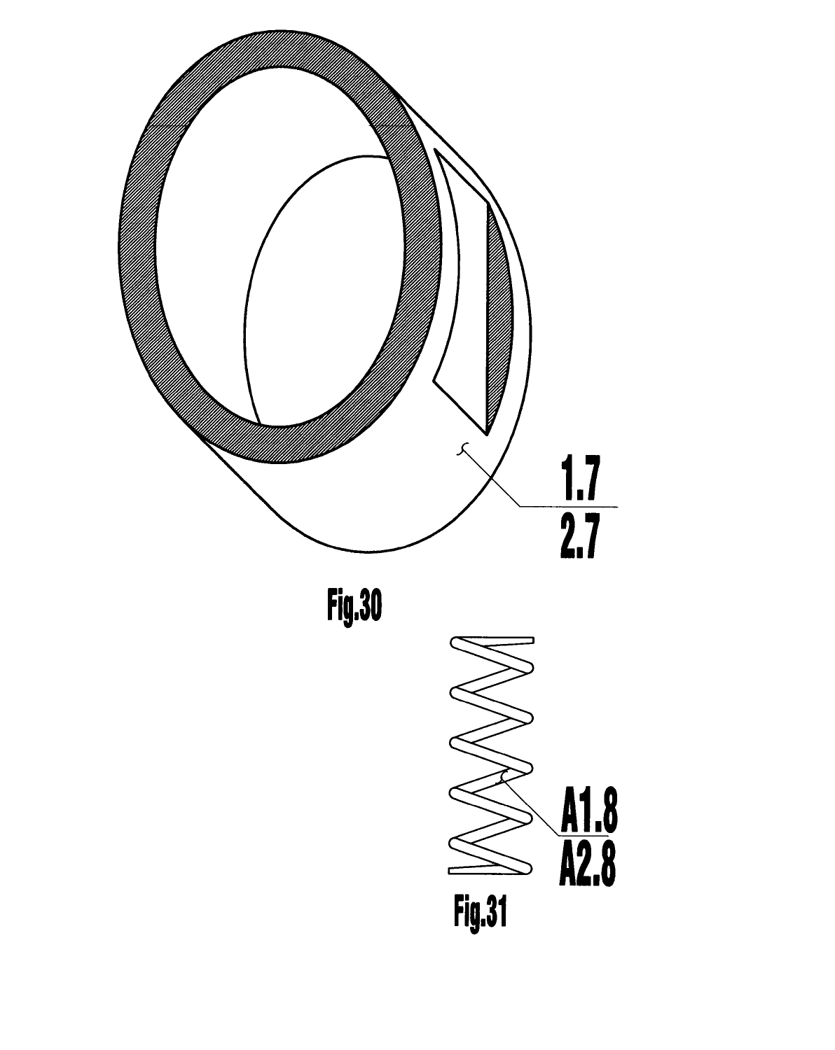

FIG. 30; It is the perspective view of the sliding element (A1.7) and (A2.7).

FIG. 31; It is the perspective view of the spring element (A1.8) and (A2.8).

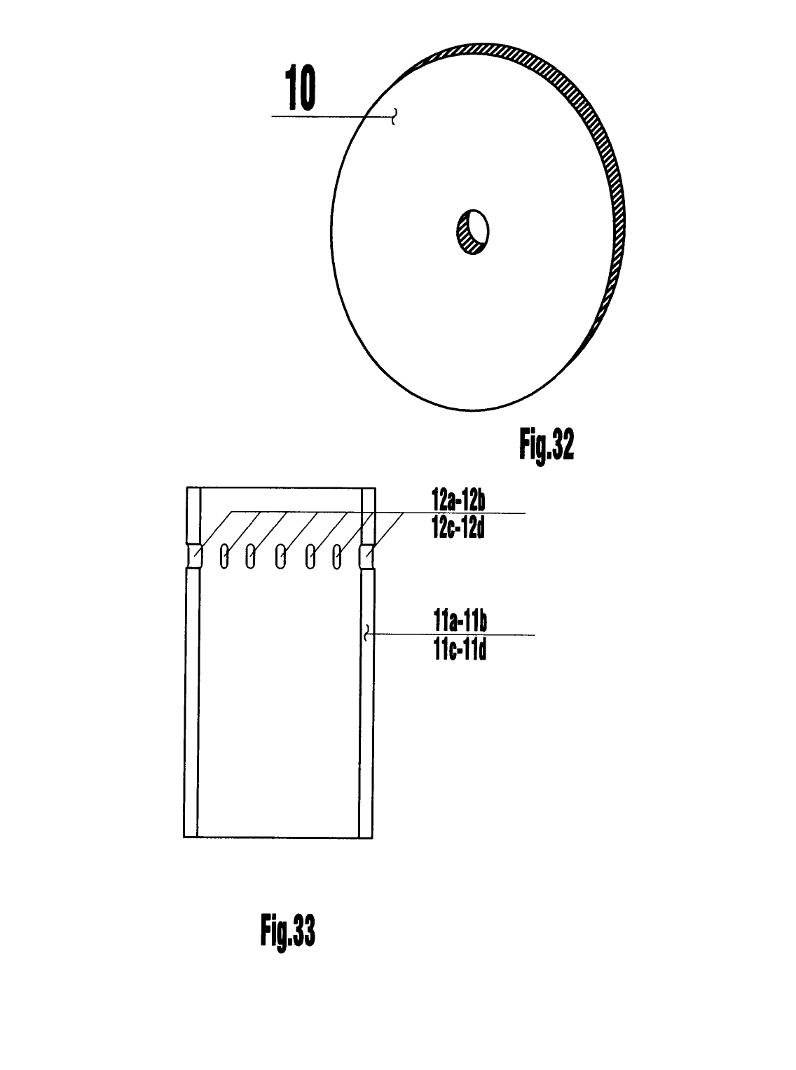

FIG. 32; It is the perspective view of the flywheel guard (10).

FIG. 33; It is the section view of the cylinder press volumes (11a-11b-11c-11d) and compressed gas inlet (12a-12b-12c-12d).

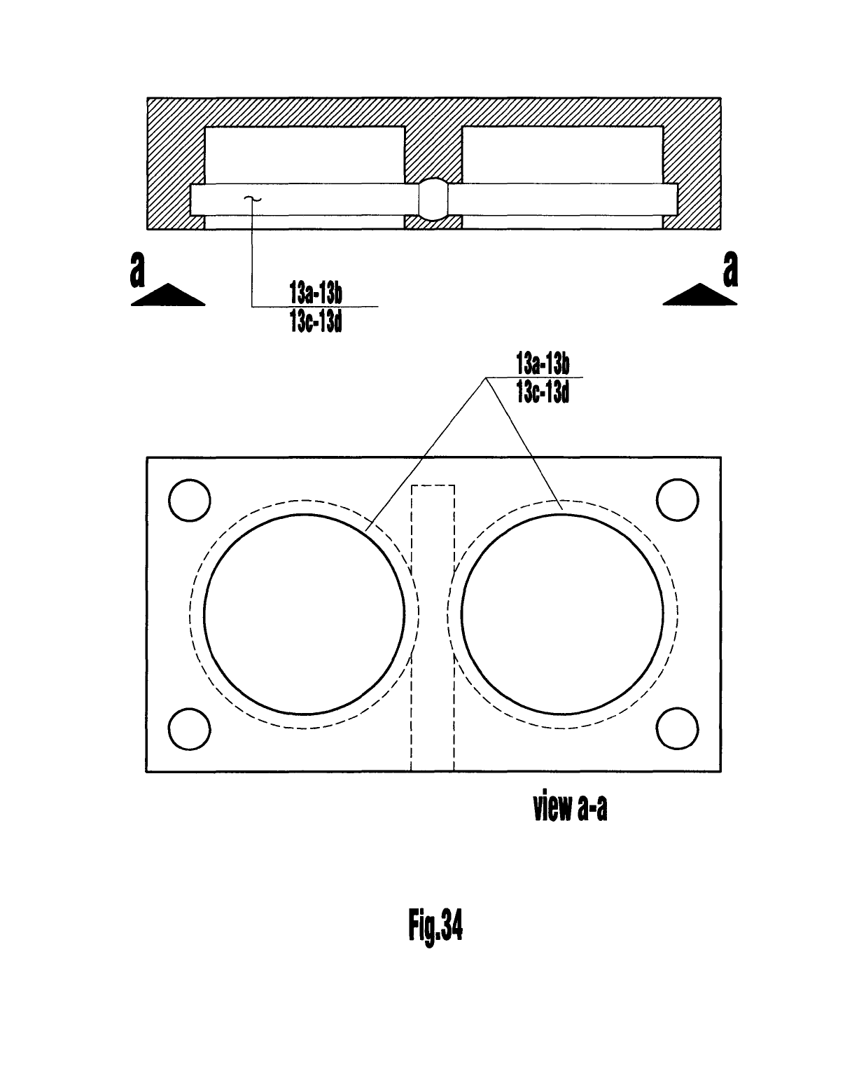

FIG. 34; It is the plan and section view of the pressure gas balancing channel (13a-13b-13c-13d).

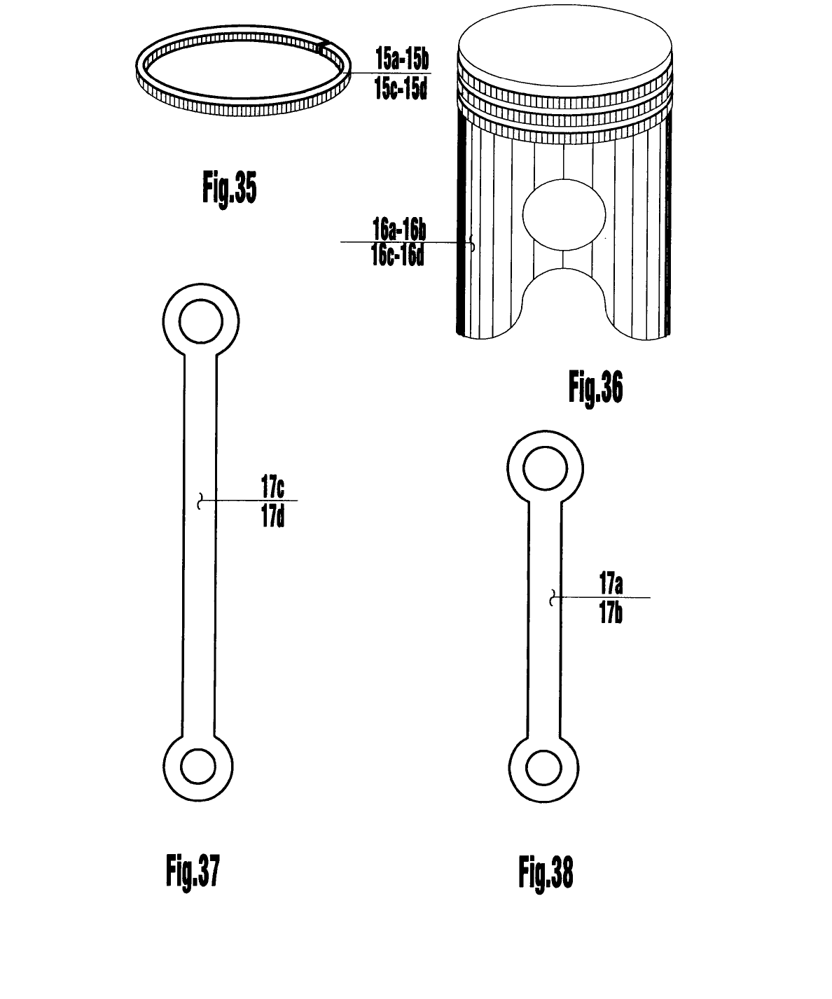

FIG. 35; It is the perspective view of the pressure segment element (15a-15b-15c-15d).

FIG. 36; It is the perspective view of the piston element (16a-16b-16c-16d).

FIG. 37; It is the plan view of the long piston rod element (17c) and (17d).

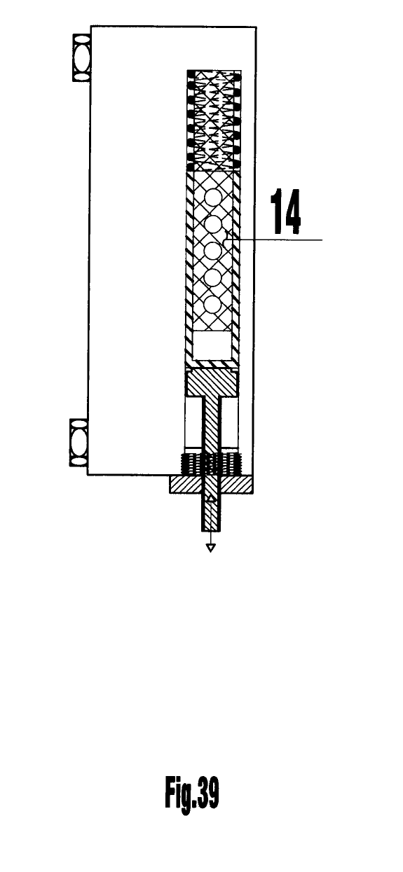

FIG. 38; It is the plan view of the short piston rod element (17a) and (17b).

FIG. 39; It is the section view of the pressure control valve element (14).

### EXPLANATIONS OF THE REFERENCES IN THE ILLUSTRATIONS,

MK) Engine housing;

A1.1) Hammer element

A2.1) Hammer element

A1.2) Shuttle element

A2.2) Shuttle element
3) Disk element
   4) Symmetric disk element

A1.5) Eccentric element

A2.5) Eccentric element
6) Gear grup

A1.7) Sliding element

A2.7) Sliding element

A1.8) Spring element

A2.8) Spring element
9) Engine oil
10) Flywheel guard
   BH) Press volumes;

11a) Cylinder press volume

11b) Cylinder press volume

11c) Cylinder press volume

11d) Cylinder press volume

12a) Compressed gas inlet

12b) Compressed gas inlet

12c) Compressed gas inlet

12d) Compressed gas inlet

13a) Pressure gas balancing channel

13b) Pressure gas balancing channel

13c) Pressure gas balancing channel

13d) Pressure gas balancing channel

14) Pressure control valve

15) Pressure segment

16 a) Piston element

16 b) Piston element

16 c) Piston element

16 d) Piston element

17 a) Piston rods

17 b) Piston rods

17 c) Piston rods

17 d) Piston rods

### EXPLANATION FOR THE INVENTION

The subject of the invention is ‘the apparatus that transforms the energy in the compressed gases into rotational movement’ and this technology that Works under constant pressure, has two main groups; engine housing (MK) that functions as a compressed gas tank and the press volumes (BH). After placing of this mechanic setup anti-symmetrically to each other, the mechanic setup which gets the feature to be able to make four operations in one tour of time is a technology motor that makes the transformation of the potential energy in the compressed gases without the chemical reaction. The compressed gas volume in the apparatus's tank does not change during these processes, the energy that it produces is in direct proportion to the compressed gas pressure and it has no connection with the mass of the technological motor. The analysis of features of the two apparatuses; (A1) and (A2) in the engine housing (MK) and the press volumes (BH) of the motor which is environment friendly, technological and has zero emission.

Apparatus; A1

When you apply linear force to the hammer element (A1.1) of this apparatus that functions according to the leverage principle, it makes its oscillation motion in the oscillation angle and transfers that to disk element (3) through shuttle element (A1.2) at the tip of the load. The eccentric elements (A1.5), which indirectly accelerate with this pressure force, in connection with the motion of the gear group (6) which rotate reversely to each other, make the disk element (3), which becomes active through the sliding element (A1.7) and its motions via the spring (A1.8). Do the two centered motion movement. While the shuttle element (A1.2), which transfers these two motions to each other, makes the rotational motions in 90° clockwise and in 90° counter clockwise, the eccentric center completes the oscillation angle spring two times in one tour of rotation time, and its center completes diagram motion of the infinity symbol, which is formed with the two centered motion of the disk element (3), in one tour of rotation time. During this motion, the rotation and eccentric centers of the eccentric element (A1.5) are lined one time each on a straight line, clockwise and counter clockwise. And the points, which the straight line of the axis of the hammer element (A1.1) makes 15.6° angle with the oscillation point angle two times, are the rotation points of the shuttle element (A1.2), which makes the oscillation motions connected with the hammer element (A1.1). Before these points, the disk element (3) depends on the motions of the hammer element (A1.1) in both directions and the shuttle element (A1.2) can do its two-way motions. After this point, the bearing that is the shuttle element (A1.2), which cannot do its rotational motion back as it depends on the two centered motion movement of the disk element (3), turns into a leverage whose eccentric center functions as the tip of the load. And although a linear force is applied in the reverse direction of the ongoing oscillation motion of the hammer element (A1.1), There is another opposing force bigger than this linear force and after the shuttle element (A1.2) continues its oscillation motion in 15.6° until the oscillation point angle, when the 15.6° angle distance is opened, the eccentric element (A1.5) makes a rotational motion in 90°. This feature happens in the two rotation points, in clockwise and counter clockwise directions.

Apparatus; A2

When you apply linear force to the hammer element (A2.1) of this apparatus that functions according to the leverage principle; it makes its oscillation motion in the oscillation angle and transfers that to symmetric disk element (4) through shuttle element (A2.2) at the tip of the load. The eccentric elements (A2.5), which indirectly accelerate with this pressure force, in connection with the motion of the gear group (6) which rotate reversely to each other, make the symmetric disk element (4), which becomes active through the sliding element (A2.7) and its motions via the spring (A2.8), do the two centered motion movement. While the shuttle element (A2.2), which transfers these two motions to each other, makes the rotational motions in 90° clockwise and in 90° counter clockwise; the eccentric center completes the oscillation angle spring two times in one tour of rotation time, and its center completes diagram motion of the infinity symbol, which is formed with the two centered motion of the symmetric disk element (4), in one tour of rotation time. During this motion, the rotation and eccentric centers of the eccentric element (A2.5) are lined one time each on a straight line, clockwise and counter clockwise. And the points, which the straight line of the axis of the hammer element (A2.1) makes 19.4° angle with the oscillation point angle two times, are the rotation points of the shuttle element (A2.2), which makes the oscillation motions connected with the hammer element (A2.1). Before these points, the symmetric disk element (4) depends on the motions of the hammer element (A2.1) in both directions and the shuttle element (A2.2) can do its two-way motions. After this point, the bearing that is the shuttle element (A2.2), which cannot do its rotational motion back as it depends on the two centered motion movement of the symmetric disk element (4), turns into a leverage whose eccentric center functions as the tip of the load. And although a linear force is applied in the reverse direction of the ongoing oscillation motion of the hammer element (A2.1), There is another opposing force bigger than this linear force and after the shuttle element (A2.2) continues its oscillation motion in 19.4° until the oscillation point angle, when the 19.4° angle distance is opened, the eccentric element (A2.5) makes a rotational motion in 90°. This feature happens in the two rotation points, in clockwise and counter clockwise directions.

Press Volumes; BH

There are four cylinder press volumes (11a-11b-11c-11d) in this group which also do the duty of compressed gas tank. It is a mechanical setup that has a compressed gas inlet (12a-12b-12c-12d) between each group, which forms two teams and functions as a communicating vessel; and the pressure control valves (14), which provide the gases in the pressure volumes to be compressed equally and control the compressed gas pass going to the pressure gas balancing channels (13a-13b-13c-13d); and that is connected to the hammer elements (A1.1) and (A2.1) of the apparatus through the piston rods (17a-17b-17c-17d) of piston elements (16a-16b-16c-16d) whit pressure segment (15) within these two groups. And it is the absolute part of technological motor which provides the conversion of the energy in the compressed gases into rotational motion. The apparatus that transforms the energy in the compressed gases into rotational movement; The distance of the two rotation starting points is the rotational time in 180° which is formed in the horizontal positions, in clockwise and counter clockwise directions, of the setup apparatus (A1) which is under constant pressure and has a compressed gas tank for the engine housing (MK). Having the anti-symmetry of this, the apparatus (A2) makes the two rotational starting points when they are in diagonal positions and the distance of these two rotational starting points is the rotational time of 180°. The system's shift from the horizontal position into the diagonal position is the rotational time in 90°. The four operations that is makes in one tour of time has the order of the sequential system's compressed gas pressing periods (11a-11b-11c-11d) which happens in the ranges of rotation time in 90°.

Determining the waiting times of the system according to this order; When it comes to the level of the compressed gas inlet (12a) of the pressure gas balancing cannel (13a) with the upward movement of the piston element (16a) in the cylinder press volume (11a), the piston element (16d) of the cylinder press volume (11d) in the anti-symmetric system completes its upward movement and when the pressure gas balancing cannel (13d) comes to the compressed gas intel (12d) level through the back rotational motion; the positions, which the pressure of the gases in the two cylinder press volumes (11a-11d) are balanced, are the first and third waiting times of the system. When the upward movement of the piston element (16b) in the cylinder press volume (11b) comes to the level of pressure gas inlet (12b) of the pressure gas balancing channel (13b), the piston element (16c) of the cylinder press volume (11c) in the anti-symmetric system completes its upward movement and when the pressure gas balancing channel (13c) comes to the compressed gas inlet (12c) level through the back rotational motion, the positions, which the pressure of the gases in the two cylinder press volumes (11b-11c) are balanced, are the second and fourth waiting times of the system. This system makes four pressing operations and four waiting times in one four of rotation time. When rotational force is applied to flywheel guards (10) of the apparatus whose the waiting time is in the clockwise direction and horizontal position, which hurls the (A1) and (A2) engine oil and continue its momentum; the oscillation motions of the hammer element (A1.1) push the piston element (16a) in the cylinder press volume (11a) via the piston rod (17a) and when the pressure gas balancing channel (13a) closes the compressed gas tip oscillation angle, the shuttle element (A1.2) starts to produce opposing force. The piston element (16a), Which continues its movements connected with the hummer element (A1.1), completes its oscillation motion in 15.6° although it increases the pressure of the gas that it compresses at the rate of (1×10). And when the piston element (16a), which is hurled by the effect of high pressure, comes on the compressed gas inlet (12a) again; the oscillation motions of the hammer element (A2.1) of the symmetric system push the piston element (16c) in the cylinder press volume (11c) via the piston rod (17c). And when the pressure gas balancing channel (13c) closes the compressed gas inlet (12c), when it passes the rotation point having the distance in 19.4° to the tip oscillation angle, the shuttle element (A2.2) starts to produce opposing force. The piston element (16c), which continues its motions connected with the hummer element (A2.1), completes its oscillation motion in 19.4° although it increases the pressure of the gas that it compresses at the rate of (1×10). And when the piston element (16c), which is hurled by the effect of high pressure, comes on the compressed gas inlet (12c) again, the oscillation motions of the hummer element (A1.1) of the symmetric system push the piston element (16b) in the cylinder press volume (11b) via the piston rod (17.b). And when it closes the compressed gas inlet (12b) of the pressure gas balancing cannel (13b), when it passes the rotation point which has the distance in 15.6° to the tip oscillation angle, the shuttle element (A1.2) starts to produce opposing force. The piston element (16b), which continues its movements connected with the hammer element (A1.1), completes its oscillation motion in 15.6° although it increases the pressure of the gas that it compresses at the rate of (1×10). And when the piston element (16b), which is hurled by the effect of high pressure, comes on the compressed gas inlet (12b) again, the oscillation motions of the hummer element (A2.1) of the symmetric system push the piston element (16d) in the cylinder press volume (11d) via the piston rod (17d). And when it close the compressed gas inlet (12d) of the pressure gas balancing channel (13d), when it passes the rotation point having the distance of 19.4° to the tip oscillation angle, the shuttle element (A2.2) starts to produce opposing force. The piston element (16d), which continues its movements connected with the hammer element (A2.1), completes its oscillation motion of 19.4° although it increases the pressure of the gas that it compresses at the rate of (1×10). And when the piston element (16d), which is hurled by the effect of high pressure, comes on the compressed gas inlet (12d) again, the technological system, which can make four operations in one tour of rotation time, is the motor technology which converts the potential energy in the compressed gasses into kinetic energy without chemical reaction.

The Invention's Form of Application Into Industry,

This technology is a motor which transforms the energy in the compressed gases into rotational motion that serves the purposes mentioned above. The apparatuses (A1 and A2) in this technological motor's engine housing (MK) works as crank shaft for converting the linear forces into rotational motion. As for the technological motor, it will used for air, land, sea and space vehicles or by combining the systems which is producing energy for the motors of these vehicles, operating with electric energy, therefore this technology with zero emission will be used in everywhere that needs energy and will be a must in the next era.

1. It is working system of the mechanical setup in the engine housing of the apparatus that transforms the energy in the compressed gases into rotational motion. Its features are; When you apply linear force to the hammer elements (A1.1) and (A2.1), which function according to the leverage principle, of these apparatuses, it is transferred to disk element (3) and symmetric disk element (4) via shuttle elements (A 1.2) and (A2.2); The anti-symmetric eccentric elements (A1.5) and (A2.5), which accelerate with pressure force, make the disk element (3) and symmetric disk element (4), which turn reversely to each other connected with the motions of the gear group (6) that are their shared elements and become active through the sliding element (A 1.7) and its motions via the spring (A1.8) and (A2.8) do the two centered rotational motion; The eccentric centers of the shuttle elements (A 1.2) and (A2.2) which transfers these two motions through their two-way motions, make their oscillation angle spring two times in one tour of rotation; also their centers make the diagram movement of infinity symbol in one tour of rotation; The rotation and eccentric centers of the eccentric element (A1.5) and (A2.5) are lined on a straight line two times. And the points, which the straight line of the axis of the hammer element (A1.1) makes 15.6° angle two times with the oscillation point angle, are determined as the rotation points of the shuttle element (A 1.2);
Eccentric centers of the eccentric shafts (A 1.5) and (A2.5) have vertical and perpendicular position two times. And the points, which the straight line of the axis of the hummer element (A2.1) makes 19.4° angle two times with the oscillation point angle, are determined as the rotation points of the shuttle element (A2.2); Before these points, the shuttle elements (A 1.2) and (A2.2) make their movements in both directions, after that the bearing, which is the center of the shuttle element (A1.2) and (A2.2), which does not do the back rotation as it depends on the two centered rotational motions of the disk element (3) and symmetric disk element (4), turns into a leverage whose eccentric center functions as the tip of the load; Although a linear force is applied reverse to the ongoing oscillation motions of the hummer elements (A1.1) and (A2.1), the shuttle elements (A1.2) and (A2.2) creates an opposing force bigger than this linear force. And the features, which make these oscillation motions continue until the tip of the oscillation straight line and make them hurled, are happening in the four rotation points as well.

2. It is an apparatus that transforms the energy in the compressed gases into rotational motion as in claim 1. Its feature; It has the hammer elements (A 1.1) and (A2.1) that operates according to the leverage principle, it transfers to the disk element (3) and symmetric disk element (4) through the shuttle elements (A1.2) and (A2.2) in the tip of the load that convert the linear forces into oscillation motion.

3. It is an apparatus that transforms the energy in the compressed gases into rotational motion as in claim 1. Its feature; After the dependent motions of the eccentric shuttle elements (A1.2) and (A2.2), on the hammer elements (A 1.1) and (A2.1), it produces an opposing force when it is dependent on the two centered motion motions of the disk element (3) and symmetric disk element (4).

4. It is an apparatus that transforms the energy in the compressed gases into rotational motion as in claim 1. Its feature; the disk element (3) and symmetric disk element (4) that function in an anti-symmetric position to each other, make the system do four operations in one tour of time through the pressure force reflected from the shuttle element (A1.2) and (A2.2), through the two centered motions of the eccentric elements (A1.5) and (A2.5) depending on their movements in the anti-symmetric position.

5. It is an apparatus that transforms the energy in the compressed gases into rotational motion as in claim 1. Its feature; the eccentric elements (A1.5) and (A2.5) in reverse direction to each other get their rotational motion from gear group (6) elements which are their shared elements and make the disk element (3) and symmetric disk element (4) do two centered motion movement.

6. It is an apparatus that transforms the energy in the compressed gases into rotational motion as in claim 1. Its feature; Its gear group (6) has four elements contacting each other and it makes the eccentric elements (A1.5) and (A2.5), which are in anti-symmetric position to each other in their gears on the two sides, rotate in reverse direction to each other.

7. It is an apparatus that transforms the energy in the compressed gases into rotational motion as in claim 1. Its feature; The system jointly uses the sliding elements (A1.7) and (A2.7), disk element (3) and symmetric disk element (4) and eccentric (A1.5) and (A2.5).

8. It is an apparatus that transforms the energy in the compressed gases into rotational motion as in claim 1. Its feature; The sliding elements (A1.8) and (A2.8) make the two centered motion movements of the disk elements (3) and symmetric disk element (4) active.

9. This technology has a mechanical setup consisting two main groups of engine housing (MK) and press volumes (BH), this mechanical setup, which can do four operations in one tour of time upon placing symmetrically and anti-symmetrically some mechanical elements in the engine housing (MK), is the motor that converts the potential energy in the compressed gases into kinetic energy without the chemical reaction. Its feature; When you apply rotational force to the flywheel guard (10), which hurls the motor oil (9) in the engine housing (MK) of the apparatus in horizontal position and its waiting time is in clockwise direction and provides the momentum of the apparatus, the oscillation motions of the hammer element (A1.1) push the piston element (16a) with pressure segment (15) in the cylinder press volume (11a), via the piston rod (17a); And when it closes the compressed gas inlet (12a) of the pressure gas balancing channel (13a) the shuttle element (A1.2) that passes the rotation point starts to create opposing force; And although the piston element (16a) with pressure segment (15), which continues its motions depending on the hammer element (A 1.1), increases the pressure of the gas that it compresses, it makes the oscillation motion of 15.6° continue; And when the piston element (16a) with pressure segment (15), which is hurled by the effect of the high pressure, comes on the compressed gas inlet (12a) again, the oscillation motions of the hammer element (A2.1) of the symmetric system push piston element (16c) with pressure segment (15) in the cylinder press volume (11c) via piston rod (17c); And when it closes the compressed gas inlet (12c) of the pressure gas balancing channel (13c), the shuttle element (A2.2) that passes the rotation point starts to produce opposing force; And although the piston element (16c) with pressure segment (15), which continues its motions depending on the hammer element (A2.1), increases the pressure of the gas that it compresses, it makes the oscillation motion of 19.4° continue; And when the piston element (16c) with pressure segment (15), which is hurdled by the high pressure, comes on the compressed gas inlet (12c) again; the oscillation motions of the hammer element (A 1.1) of the symmetric system push piston element (16c) with pressure segment (15) in the cylinder press volume (11b) via piston rod (17b); And when it closes the compressed gas inlet (12b) of the pressure gas balancing channel (13b), the shuttle element (A 1.2) that passes the rotation point starts to produce opposing force. And although the piston element (16b) with pressure segment (15), which continues its movements depending on the hammer element (A1.1), increases the pressure of the gas that it compresses, it makes the oscillation motion of 15.6° continue; And when the piston element (16b) with pressure segment (15), which is hurled by the effect of the high pressure, comes on the compressed gas inlet (12b) again, the oscillation motions of the hammer element (A2.1) of the symmetric system push piston element (16d) with pressure segment (15) in the cylinder press volume (11d) via piston rod (17d); And when it closes the compressed gas inlet (12d) of the pressure gas balancing channel (13d), the shuttle element (A2.2) that passes the rotation point starts to produce opposing force; And although the piston element (16d) with pressure segment (15), which continues its motions depending on the hammer element (A2.1), increases the pressure of the gas that it compresses, it makes the oscillation motion of 19.4° continue; And when the piston element (16d) with pressure segment (15), which is hurdled by the effect of the high pressure, comes on the compressed gas inlet (12d) again, this technology, which converts the potential energy in the compressed gases into kinetic energy without chemical reaction, is a motor which is controlled by the pressure control valve (14) for the fast or slow operation of the technological system that can do four operations in one tour of time.

10. It is an apparatus that transforms the energy in the compressed gases into rotational motion as in claim 9. Its feature; The machine oil (9) has a liquid that decreases the frictions in the engine housing (MK) of the technological system.

11. It is an apparatus that transforms the energy in the compressed gases into rotational motion as in claim 9. Its feature; The flywheel guards (10) continue its momentum after the apparatus accelerates.

12. It is an apparatus that transforms the energy in the compressed gases into rotational motion as in claim 9. Its feature; The piston rods (17a-17b-17c-17d) transfer the oscillation motions of the hammer elements (A 1.1) and (A2.1) to the piston elements (16a-16b-16c-16d).

13. It is an apparatus that transforms the energy in the compressed gases into rotational motion as in claim 9. Its feature; The cylinder press volumes (11a-11b-11c-11d) function as a bed for the piston elements (16a-16b-16c-16d) and provide the cell formation for pressing the compressed gas.

14. It is an apparatus that transforms the energy in the compressed gases into rotational motion as in claim 9. Its feature; The pressure segments (15a-15b-15c-15d) functions as a bed for the piston elements (16a-16b-16c-16d) and does not leak the gas.

15. It is an apparatus that transforms the energy in the compressed gases into rotational motion as in claim 9. Its feature; Its piston elements (16a-16b-16c-16d) are furnished with the pressure segment (15a-15b-15c-15d) that function as a bed and compress the gases in the press volumes (11a-11b-11c-11d) through reciprocating motions.

16. It is an apparatus that transforms the energy in the compressed gases into rotational motion as in claim 9. Its feature; Its pressure gas balancing channels (13a-13b-13c-13d) are in the level of compressed gas inlet (12a-12b-12c-12d) at 15.6° and 19.4° and it has a circular channel on the outer surface of the pressure volumes (11a-11b-11c-11d) and it transfers the compressed gas in the two pressure volumes (11a-11b) and (11c-11d) to each other, with a feature of communicating vessel.

17. It is an apparatus that transforms the energy in the compressed gases into rotational motion as in claim 9. Its feature; Its compressed gas inlet (12a-12b-12c-12d) housing is the position when the system is on the rotation point at 15.6° and 19.4° and it can arrange the entry and exit time of the compressed gas without a delay.

18. It is an apparatus that transforms the energy in the compressed gases into rotational motion as in claim 9. Its feature; It equalizes the pressures of the gases in the pressure volumes (11a-11b-11c-11d) by arranging the passing speed and flow of the gases via the pressure control valve (14) and it provides the technological motor to operate in fast or slow cycle.
